(19) United States
(12) Patent Application Publication
(10) Pub. No.: US 2024/0380345 A1
(43) Pub. Date: Nov. 14, 2024

(54) POWER CONVERTING APPARATUS, MOTOR DRIVE UNIT, AND REFRIGERATION CYCLE-INCORPORATING APPARATUS

(71) Applicant: Mitsubishi Electric Corporation, Tokyo (JP)

(72) Inventors: Haruka MATSUO, Tokyo (JP); Tomohiro KUTSUKI, Tokyo (JP); Takaaki TAKAHARA, Tokyo (JP); Koichi ARISAWA, Tokyo (JP); Kenji TAKAHASHI, Tokyo (JP)

(21) Appl. No.: 18/690,045

(22) PCT Filed: Oct. 28, 2021
(86) PCT No.: PCT/JP2021/039841

§ 371 Date: Mar. 7, 2024

(51) Int. Cl. H02P 21/05; H02P 21/26; H02P 27/08

(52) U.S. Cl. CPC H02P 21/05; H02P 21/26; H02P 27/085

(57) ABSTRACT

The power converting apparatus includes a rectifier unit rectifying first alternating-current power, a capacitor connected to the rectifier unit, an inverter connected across the capacitor to output second alternating-current power to a motor, a voltage detection unit detecting a power state of the capacitor, and a control unit controlling operations of the inverter and the motor, using a dq-rotational coordinate system rotating in synchronization with a rotor position of the motor. The control unit superimposes a q-axis current pulsation on a drive pattern of the motor in accordance with a detection value of the voltage detection unit to reduce a charge-discharge current of the capacitor, and to cause a d-axis current to the motor to pulsate in synchronization with a frequency that is a positive integer multiple of a frequency of the q-axis current pulsation saturation of a voltage of the inverter.

### FIELD

The present disclosure relates to a power converting apparatus for converting alternating-current (AC) power into desired power, and to a motor drive unit and a refrigeration cycle-incorporating apparatus.

### BACKGROUND

Many conventional power converting apparatuses are connected to those which have periodically varying load torque, i.e., mechanical devices having periodical load torque pulsations. Mechanical devices, motors serving as power sources of the mechanical devices, etc. may make vibration, noise, etc. because of load torque pulsations. As such, various technologies for vibration reducing control have been studied. Meanwhile, when an attempt is made to perform vibration reducing control during high-speed rotation, efficiency in driving a motor may decrease because a large d-axis current needs flowing on average to ensure a large tolerance in percentage modulation. To address such problem, Patent Literature 1 discloses a technology for reducing a decrease in efficiency as well as performing vibration reducing control in an overmodulation range.

### CITATION LIST

### Patent Literature

Patent Literature 1: WO 2020/234971 A

### SUMMARY OF INVENTION

### Problem to be Solved by the Invention

For a power converting apparatus, in general, a rectifier unit rectifies AC power supplied from an AC power supply, a smoothing capacitor then smooths the resulting power, and an inverter made up of multiple switching elements converts the resulting power into desired AC power, and outputs the resulting AC power to a motor. A problem with the foregoing conventional technology is that a high current flowing into the smoothing capacitor accelerates aging degradation of the smoothing capacitor. A possible ways to address such a problem is to increase the capacity of the smoothing capacitor to thereby reduce ripple fluctuation in the capacitor voltage. Another way is to use a smoothing capacitor having higher resistance to degradation due to ripple. However, these approaches will result in an increase in cost of capacitor components, and an increase in the size of the apparatus.

The present disclosure has been made in view of the foregoing, and it is an object of the present disclosure to provide a power converting apparatus capable of reducing a decrease in efficiency as well as reducing degradation of the smoothing capacitor.

### Means to Solve the Problem

To solve the problem and achieve the object, a power converting apparatus according to the present disclosure comprises: a rectifier unit rectifying first alternating-current power supplied from a commercial power supply; a capacitor connected to an output end of the rectifier unit; an inverter connected across the capacitor, the inverter generating second alternating-current power and outputting the second alternating-current power to a motor; a detection unit detecting a power state of the capacitor; and a control unit controlling an operation of the inverter and an operation of the motor, using a dq-rotational coordinate system, the dq-rotational coordinate system rotating in synchronization with a rotor position of the motor. The control unit superimposes a q-axis current pulsation on a drive pattern of the motor in accordance with a detection value of the detection unit to reduce a charge-discharge current of the capacitor, and to cause a d-axis current to the motor to pulsate in synchronization with a frequency that is a positive integer multiple of a frequency of the q-axis current pulsation during saturation of a voltage of the inverter, the q-axis current pulsation being a pulsatile component of a q-axis current

### Effects of the Invention

A power converting apparatus according to the present disclosure provides an advantage of reducing the decrease in efficiency as well as reducing the degradation of the smoothing capacitor.

### BRIEF DESCRIPTION OF DRAWINGS

FIG. 1 is a diagram illustrating an example configuration of a power converting apparatus according to a first embodiment.

FIG. 2 is a block diagram illustrating an example configuration of a control unit of the power converting apparatus according to the first embodiment.

FIG. 3 is a diagram illustrating, as a comparative example, an example of drive waveform provided by a power converting apparatus having a circuit configuration similar to the circuit configuration of the power converting apparatus of the first embodiment.

FIG. 4 is a diagram illustrating an example of drive waveform provided by the power converting apparatus according to the first embodiment.

FIG. 5 is a block diagram illustrating an example configuration of a flux-weakening control unit of the control unit of the power converting apparatus according to the first embodiment.

FIG. 6 is a diagram illustrating a voltage command when flux-weakening control is performed by the flux-weakening control unit of the control unit of the power converting apparatus according to the first embodiment.

FIG. 7 is a first diagram illustrating a simple method for calculating a d-axis current pulsation, for use in the flux-weakening control unit according to the first embodiment.

FIG. 8 is a second diagram illustrating the simple method for calculating the d-axis current pulsation, for use in the flux-weakening control unit according to the first embodiment.

FIG. 9 is a flowchart illustrating an operation of the control unit of the power converting apparatus according to the first embodiment.

FIG. 10 is a flowchart illustrating an operation of the flux-weakening control unit of the control unit of the power converting apparatus according to the first embodiment.

FIG. 11 is a diagram illustrating an example of hardware configuration for implementing the control unit of the power converting apparatus according to the first embodiment.

FIG. 12 is a diagram illustrating a control error in the flux-weakening control performed by the flux-weakening control unit of the control unit of the power converting apparatus according to the first embodiment.

FIG. 13 is a block diagram illustrating an example configuration of a control unit of the power converting apparatus according to a second embodiment.

FIG. 14 is a diagram illustrating a control error in the flux-weakening control performed by a flux-weakening control unit of the control unit of the power converting apparatus according to the second embodiment.

FIG. 15 is a block diagram illustrating an example configuration of the flux-weakening control unit of the control unit of the power converting apparatus according to the second embodiment.

FIG. 16 is a diagram for describing the flux-weakening control performed by the flux-weakening control unit of the control unit of the power converting apparatus according to the second embodiment.

FIG. 17 is a flowchart illustrating an operation of the flux-weakening control unit of the control unit of the power converting apparatus according to the second embodiment.

FIG. 18 is a block diagram illustrating an example configuration of a control unit of the power converting apparatus according to a third embodiment.

FIG. 19 is a block diagram illustrating an example configuration of a flux-weakening control unit of the control unit of the power converting apparatus according to the third embodiment.

FIG. 20 is a block diagram illustrating an example configuration of a d-axis current pulsation generation unit according to the third embodiment.

FIG. 21 is a flowchart illustrating an operation of the flux-weakening control unit of the control unit of the power converting apparatus according to the third embodiment.

FIG. 22 is a diagram illustrating an example of frequency analysis result of an ideal d-axis current pulsation.

FIG. 23 is a block diagram illustrating an example configuration of the d-axis current pulsation generation unit according to a fourth embodiment.

FIG. 24 is a flowchart illustrating an operation of the flux-weakening control unit of the control unit of the power converting apparatus according to the fourth embodiment.

FIG. 25 is a diagram illustrating an example of waveforms of current commands in a light load range.

FIG. 26 is a diagram illustrating an example of waveforms of the current commands in a heavy load range.

FIG. 27 is a block diagram illustrating an example configuration of a control unit of the power converting apparatus according to a fifth embodiment.

FIG. 28 is a flowchart illustrating an operation of a q-axis current pulsation computing unit of the control unit of the power converting apparatus according to the fifth embodiment.

FIG. 29 is a diagram illustrating an example configuration of a power converting apparatus according to a sixth embodiment.

FIG. 30 is a block diagram illustrating an example configuration of a control unit of the power converting apparatus according to the sixth embodiment.

FIG. 31 is a diagram illustrating an example configuration of a refrigeration cycle-incorporating apparatus according to a seventh embodiment.

### DESCRIPTION OF EMBODIMENTS

A power converting apparatus, a motor drive unit, and a refrigeration cycle-incorporating apparatus according to embodiments of the present disclosure will be described in detail below with reference to the drawings.

### First Embodiment

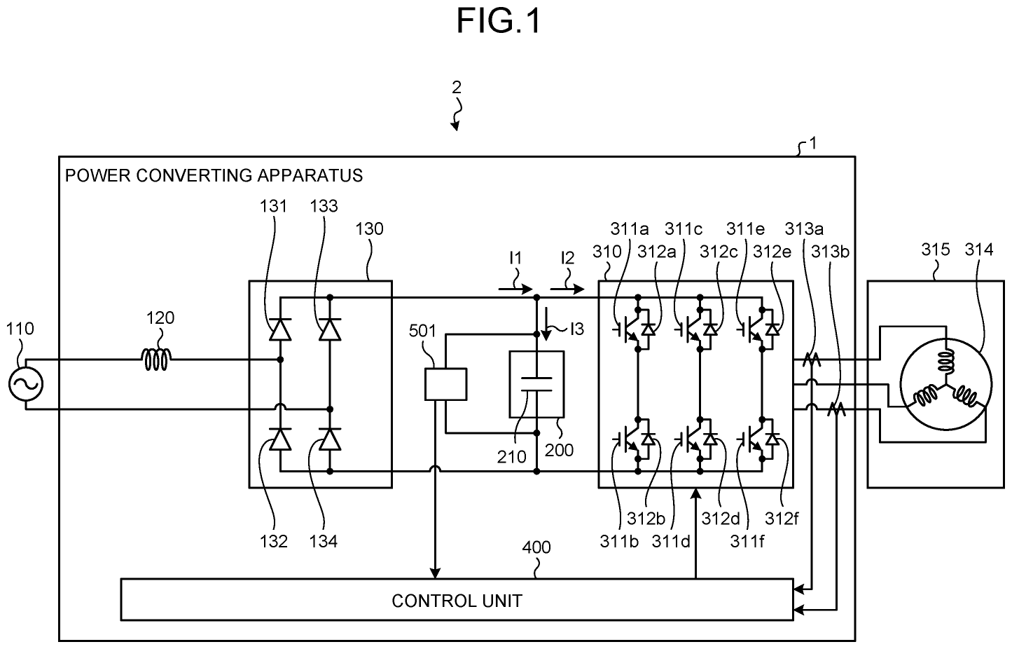

FIG. 1 is a diagram illustrating an example configuration of a power converting apparatus 1 according to a first embodiment. The power converting apparatus 1 is connected to a commercial power supply 110 and a compressor 315. The power converting apparatus 1 converts first alternating-current (AC) power into second AC power, and supplies the second AC power to the compressor 315. The first alternating-current (AC) power has a supply voltage Vs supplied from the commercial power supply 110. The second AC power has a desired amplitude and phase. The power converting apparatus 1 includes a reactor 120, a rectifier unit 130, a voltage detection unit 501, a smoothing unit 200, an inverter 310, current detection units 313a and 313b, and a control unit 400. Note that the power converting apparatus 1 and a motor 314 of the compressor 315 form a motor drive unit 2.

The reactor 120 is connected between the commercial power supply 110 and the rectifier unit 130. The rectifier unit 130 includes a bridge circuit including rectifier elements 131 to 134 to rectify the first AC power having the supply voltage Vs supplied from the commercial power supply 110, and outputs the thus rectified power. The rectifier unit 130 provides full-wave rectification. The voltage detection unit 501 detects a direct-current (DC) bus voltage V_{dc}. The direct-current (DC) bus voltage V_{dc} is the voltage across the smoothing unit 200 charged with current flowing from the rectifier unit 130 into the smoothing unit 200 after being rectified by the rectifier unit 130. The voltage detection unit 501 outputs the detected voltage value to the control unit 400. The voltage detection unit 501 is a detection unit that detects a power state of the capacitor 210.

The smoothing unit 200 is connected to output ends of the rectifier unit 130. The smoothing unit 200 includes the capacitor 210 as a smoothing element to smooth the power rectified by the rectifier unit 130. The capacitor 210 is, for example, an electrolytic capacitor, a film capacitor, or the like. The capacitor 210 is connected to the output ends of the rectifier unit 130. The capacitor 210 has a capacity sufficient for smoothing the power rectified by the rectifier unit 130. The voltage across the capacitor 210 obtained by smoothing does not have a full-wave rectified waveform of the commercial power supply 110, but has a waveform including a voltage ripple superimposed on a DC component, which voltage ripple is dependent on the frequency of the commercial power supply 110. The foregoing voltage across the capacitor 210 thus does not pulsate largely. This voltage ripple has a frequency twice the frequency of the supply voltage Vs when the commercial power supply 110 is a single-phase power supply, and has a main component at a frequency six times the frequency of the supply voltage Vs when the commercial power supply 110 is a three-phase power supply. When neither the power input from the commercial power supply 110 nor the power output from the inverter 310 varies, the amplitude of this voltage ripple depends on the capacity of the capacitor 210. For example, the voltage ripple occurring on the capacitor 210 pulsates within a range having a maximum value less than twice the minimum value.

The inverter 310 is connected across the smoothing unit 200, that is, connected across the capacitor 210. The inverter 310 includes switching elements 311a to 311f and freewheeling diodes 312a to 312f. The inverter 310 turns on and off the switching elements 311a to 311f under the control of the control unit 400 to convert the power output from the rectifier unit 130 and the smoothing unit 200 into second AC power having a desired amplitude and phase, i.e., to generate the second AC power, and outputs the second AC power to the compressor 315. The current detection units 313a and 313b each detect a current value of a corresponding one of three phases of the current output from the inverter 310, and each output the detected current value to the control unit 400. Note that by obtaining current values of two phases among current values of the three phases output from the inverter 310, the control unit 400 can calculate the current value of the remaining one phase output from the inverter 310. The compressor 315 is a load including the motor 314 for driving the compressor. The motor 314 rotates depending on the amplitude and the phase of the second AC power supplied from the inverter 310 to thus perform compression operation. For example, when the compressor 315 is a hermetic-type compressor for use in an air conditioner or the like, the load torque of the compressor 315 can often be regarded as constant torque load. Although FIG. 1 illustrates the motor 314 as having a motor winding of Y connection, by way of example, and the connection topology is not limited thereto. The motor 314 may have a motor winding of delta (Δ) connection, or may have a motor winding designed to be switchable between Y connection and A connection.

Note that the arrangement of the components of the power converting apparatus 1 illustrated in FIG. 1 is merely one example, and the arrangement of the components is not limited to this example illustrated in FIG. 1. For example, the reactor 120 may be disposed downstream of the rectifier unit 130. In addition, the power converting apparatus 1 may include a booster unit, or the rectifier unit 130 may be designed to have functionality of a booster unit. The voltage detection unit 501 and the current detection units 313a and 313b may each be referred to hereinafter collectively as detection unit. In addition, the voltage value detected by the voltage detection unit 501 and the current values detected by the current detection units 313a and 313b may each be referred to hereinafter as detection value.

The control unit 400 obtains the voltage value of the DC bus voltage V_{dc} of the smoothing unit 200 from the voltage detection unit 501, and obtains, from each of the current detection units 313a and 313b, the current value of the second AC power having a desired amplitude and phase obtained by conversion performed by the inverter 310. The control unit 400 controls the operation of the inverter 310, specifically, turning on and off of the switching elements 311a to 311f of the inverter 310, using the detection values detected by the individual detection units. The control unit 400 also controls the operation of the motor 314, using the detection values detected by the individual detection units. In the present embodiment, the control unit 400 controls the operation of the inverter 310 such that the inverter 310 outputs, to the compressor 315, i.e., a load, the second AC power including a pulsation dependent on the pulsation of the power flowing from the rectifier unit 130 into the capacitor 210 of the smoothing unit 200. The phrase “pulsation dependent on the pulsation of the power flowing into the capacitor 210 of the smoothing unit 200” refers to, for example, a pulsation that fluctuates according to, for example, the frequency of the pulsation of the power flowing into the capacitor 210 of the smoothing unit 200. Through such control, the control unit 400 reduces the amount of current flowing into the capacitor 210 of the smoothing unit 200. The control unit 400 does not necessarily need to use all the detection values obtained from the individual detection units, and may perform control using one or some of the detection values.

The control unit 400 provides control that brings any of the speed, the voltage, and the current of the motor 314 to a desired condition. The motor 314 is used for driving the compressor 315 that is a hermetic-type compressor, in which case the structure and cost of a position sensor for detecting the rotor position makes it difficult to attach the position sensor to the motor 314. For this reason, the control unit 400 performs position sensorless control on the motor 314. There are two types of methods of position sensorless control on the motor 314: constant primary magnetic flux control; and sensorless vector control. The present embodiment will be described, by way of example, on the basis of sensorless vector control. Note that the control method described below is also applicable to constant primary magnetic flux control with minor modification. In the present embodiment, the control unit 400 controls the operations of the inverter 310 and the motor 314, using a dq-rotational coordinate system that rotates in synchronization with the rotor position of the motor 314 as described later.

A description will be made as to a specific operation of the control unit 400 in the present embodiment. As illustrated in FIG. 1, currents in the power converting apparatus 1 are designated as follows: the input current from the rectifier unit 130 to the capacitor 210 of the smoothing unit 200 is designated as input current I1, the output current from the capacitor 210 of the smoothing unit 200 to the inverter 310 is designated as output current I2, and a charge-discharge current of the capacitor 210 of the smoothing unit 200 is designated as charge-discharge current I3. Although the input current I1 is affected by factors such as the power supply phase of the commercial power supply 110, and the characteristic of each of elements disposed upstream and downstream of the rectifier unit 130, the input current I1 basically has characteristics including a component having a frequency 2n times the power supply frequency, where n is an integer greater than or equal to 1.

When an electrolytic capacitor is used as the capacitor 210 of the smoothing unit 200, the charge-discharge current I3 having a large value will accelerate aging degradation of the capacitor 210. To reduce the charge-discharge current I3 and the aging degradation of the capacitor 210, the control unit 400 is required to control the inverter 310 such that the input current I1 to the capacitor 210 becomes equal to the output current I2 from the capacitor 210. As a ripple component caused by pulse width modulation (PWM) is superposed on the output current I2, the control unit 400 needs to control the inverter 310, taking that ripple component into consideration. To reduce the degradation of the capacitor 210, the control unit 400 is required to decrease the charge-discharge current I3 by monitoring the power states of the smoothing unit 200, i.e., the power state of the capacitor 210 and providing the motor 314 with an appropriate pulsation. In this respect, the power states of the capacitor 210 include, for example, the input current I1 to the capacitor 210, the output current I₂ from the capacitor 210, the charge-discharge current I3 of the capacitor 210, and the DC bus voltage V_{dc} of the capacitor 210. For degradation reducing control, the control unit 400 requires at least one piece of information among these power states of the capacitor 210.

In the present embodiment, using the DC bus voltage V_{dc} of the capacitor 210 detected by the voltage detection unit 501, the control unit 400 provides the motor 314 with a pulsation such that the value of the output current I₂ having the PWM ripple removed matches the value of the input current I1. That is, the control unit 400 controls the operation of the inverter 310 such that a pulsation dependent on the detection value from the voltage detection unit 501 is superimposed on a drive pattern of the motor 314, thus reducing the charge-discharge current 13 of the capacitor 210. A relationship between input power and output power to and from the motor 314 allows the control unit 400 to control a q-axis current command i_{q}* for the motor 314 so as to reduce a difference between the input current I1 and the output current I2. In the case of this control method, the control unit 400 uses a relationship between the input power to the inverter 310 and a mechanical output from the motor 314 in calculating an ideal q-axis current command i_{q}* for reducing the charge-discharge current I3. Thus, in the present embodiment, the control unit 400 performs control in a rotational coordinate system having a d-axis and a q-axis. Note that although the power converting apparatus 1 is capable of estimating the charge-discharge current I3 of the capacitor 210 from the DC bus voltage V_{dc} of the capacitor 210, the power converting apparatus 1 may include a current detection unit for detecting the charge-discharge current I3 of the capacitor 210.

In the power converting apparatus 1, the voltage detection unit 501 detects the voltage value of the DC bus voltage V_{dc} of the capacitor 210, and outputs the voltage value to the control unit 400. The control unit 400 controls the inverter 310 such that the value of the output current I2 flowing from the capacitor 210 to the inverter 310 minus the PWM ripple matches the value of the input current I1, and the control unit 400 provides a pulsation for the power output to the motor 314. The control unit 400 can reduce the charge-discharge current I3 of the capacitor 210 by causing the output current I₂ to pulsate appropriately. As described above, the input current I1 to the capacitor 210 includes a component having a frequency that is 2n times the power supply frequency, and therefore, the output current I₂ and a q-axis current i_{q} of the motor 314 also include a component having a frequency that is 2n times the power supply frequency. A specific method for calculating the q-axis current i_{q} of the motor 314 to cause the output current I₂ to appropriately pulsate is, for example, as follows.

An AC supply voltage from the commercial power supply 110, which is the input to the power converting apparatus 1, is expressed by Equation (1).

$${v}_{i n} = {V}_{s} \cdot sin ( {ω}_{i n} t ) \qquad Formula 1$$

In Equation (1), Vₛ represents the amplitude of the AC supply voltage, ωᵢₙ represents the angular frequency of the AC supply voltage, and “t” represents time. Although depending on the power supply environment, the angular frequency ωᵢₙ is 50 Hz×2π=314 rad/s or 60 Hz×2π=377 rad/s in many cases. Note that where the power converting apparatus 1 is a circuit configured to include a booster unit disposed upstream or downstream of the rectifier unit 130, the input current I1 to the capacitor 210 includes a PWM ripple. Such PWM ripple will not herein be taken into account, because the average of the PWM ripple is treated. When the input current I1 is approximated using Fourier coefficients on the assumption that the input current I1 follows a periodic function, the input current I1 can be expressed as Equation (2). The rectifier unit 130 provides the input current I1 with a waveform including many components at frequencies each of which is an integer multiple of the power supply frequency 2f. The input current I1 has a fundamental wave that is a component at the power supply frequency 2f. Note that the equation denotes “1” of input current “I1” as a subscript “1” for consistency with others. Similar notation also applies to the following description.

$$\begin{matrix}Formula 2 & \\ {I}_{1} ≡ {I}_{D C} + {I}_{2 f} sin ( 2 {ω}_{i n} t + {θ}_{2 f} ) + {I}_{4 f} sin ( 4 {ω}_{i n} t + {θ}_{4 f} ) + {I}_{6 f} sin ( 6 {ω}_{i n} t + {θ}_{6 f} ) + … & ( 2 )\end{matrix}$$

In Equation (2), I_{DC} represents a direct-current (DC) component of the current, I_{2f}, I_{4f}, I_{6f}, . . . represent the fundamental wave amplitude and harmonic wave amplitudes of the current, and θ_{2f}, θ_{4f}, θ_{6f}, . . . represent the fundamental wave phase and harmonic wave phases. The input current I1 itself may be used in control performed by the control unit 400, or the input current I1 may be used in control performed by the control unit 400 after passing through a filter. For example, assuming that an input current I1′ is defined as a current having a DC component, a fundamental wave component, and a low-order harmonic component of the input current I1 extracted by a low-pass filter and a band-pass filter, the input current I1′ can be expressed, for example, as Equation (3). In Equation (3), the input current I1′ is that which has the DC component, the power supply frequency 2f component, and the power supply frequency 4f component, all of which are extracted, but may also include a component having a power supply frequency 6f or higher. Note that the band-pass filter may be configured using a finite impulse response (FIR) filter or an infinite impulse response (IIR) filter. In addition, the input current I1′ may be calculated from a coefficient computation formula of Fourier coefficient expansion.

$$\begin{matrix}Formula 3 & \\ {I}_{1}^{′} ≡ {I}_{D C} + {I}_{2 f} sin ( 2 {ω}_{i n} t + {θ}_{2 f} ) + {I}_{4 f} sin ( 4 {ω}_{i n} t + {θ}_{4 f} ) & ( 3 )\end{matrix}$$

Only specific frequency components are extracted using the foregoing filters for the purpose of preventing the pulsation provided for the motor 314 from including an unintended frequency component. On the other hand, use of the foregoing filters reduces promptness with respect to a change in the input current I1. Whether to use filters may be therefore determined depending on the situation. The following description is based on the assumption that the foregoing filters are used. An output current command I₂* for the output current I₂ from the capacitor 210 is now given as Equation (4).

$$\begin{matrix}Formula 4 & \\ {I}_{2}^{*} = {I}_{1}^{′} ≡ {I}_{D C} + {I}_{2 f} sin ( 2 {ω}_{i n} t + {θ}_{2 f} ) + {I}_{4 f} sin ( 4 {ω}_{i n} t + {θ}_{4 f} ) & ( 4 )\end{matrix}$$

To provide a pulsation for the motor 314 such that the output current command I₂* flows in accordance with a command value, the following can be done, for example. When the output current command I₂* flows in accordance with a command value, active power Pᵢₙ input from the capacitor 210 to the motor 314 is expressed as Equation (5).

$$\begin{matrix}Formula 5 & \\ {P}_{i n =} {V}_{d c} {I}_{2}^{*} = {V}_{d c} \{ {I}_{D C} + {I}_{2 f} sin ( 2 {ω}_{i n} t + {θ}_{2 f} ) + {I}_{4 f} sin ( 4 {ω}_{i n} t + {θ}_{4 f} ) \} & ( 5 )\end{matrix}$$

In Equation (5), V_{dc} represents the DC bus voltage. Meanwhile, active power Pₘₒₜ consumed by the motor 314 is expressed as Equation (6) using dq-axis voltages and dq-axis currents.

$$\begin{matrix}Formula 6 & \\ {P}_{mot =} {v}_{d} {i}_{d} + {v}_{q} {i}_{q} & ( 6 )\end{matrix}$$

In Equation (6), V_{d} represents a d-axis voltage, V_{q} represents a q-axis voltage, i_{d} represents a d-axis current, and i_{q} represents a q-axis current. Substituting the voltage equation for the steady state of a permanent magnet synchronous motor into Equation (6) yields Equation (7).

$$\begin{matrix}Formula 6 & \\ {P}_{mot =} {v}_{d} {i}_{d} + {v}_{q} {i}_{q} = ( {R}_{a} {i}_{d} - {ω}_{e} {L}_{q} {i}_{q} ) {i}_{d} + ( {R}_{a} {i}_{q} + {ω}_{e} ( {L}_{d} {i}_{d} + {Φ}_{a} ) ) {i}_{q} & ( 7 )\end{matrix}$$

In Equation (7), Ra represents the armature resistance, L_{d} and L_{q} each represent a dq-axis inductance, Pa represents a dq-axis flux linkage, and We represents the electrical angular speed. In a case where the voltage drop due to the armature resistance Ra is negligible, and the d-axis current i_{d} can be regarded as almost zero, Equation (8) holds.

$$\begin{matrix}Formula 8 & \\ {P}_{mot} ≅ {ω}_{a} {Φ}_{a} {i}_{q} & ( 8 )\end{matrix}$$

Providing a pulsation for the motor 314 so as to satisfy a relationship of Pₘₒₜ=Pᵢₙ can reduce the current flowing to and from the smoothing unit 200, i.e., the charge-discharge current I3. A q-axis current pulsation command i_{grip}* should be therefore provided as shown by Equation (9).

$$\begin{matrix}Formula 9 & \\ {i}_{grip}^{*} = \frac{{V}_{d c}}{{ω}_{e} {Φ}_{a}} {I}_{2}^{*} = \frac{{V}_{d c}}{{ω}_{e} {Φ}_{a}} ( {I}_{D C} + {I}_{2 f} sin ( 2 {ω}_{i n} t + {θ}_{2 f} ) + {I}_{4 f} sin ( 4 {ω}_{i n} t + {θ}_{4 f} ) ) & ( 9 )\end{matrix}$$

Providing a q-axis current pulsation command i_{grip}* as shown by Equation (9) can reduce degradation of the capacitor 210 of the smoothing unit 200. Note that when the d-axis current i_{d} is non-zero, the computation may be performed also taking into account a reluctance torque as shown by Equation (10).

$$\begin{matrix}Formula 10 & \\ {i}_{grip}^{*} = \frac{{V}_{d c}}{{ω}_{e} ( {Φ}_{a} + ( {L}_{d} - {L}_{q} ) {i}_{d}^{*} )} {I}_{2}^{*} = \frac{{V}_{d c}}{{ω}_{e} ( {Φ}_{a} + ( {L}_{d} - {L}_{q} ) {i}_{d}^{*} )} ( {I}_{D C} + {I}_{2 f} sin ( 2 {ω}_{i n} t + {θ}_{2 f} ) + {I}_{4 f} sin ( 4 {ω}_{i n} t + {θ}_{4 f} ) ) & ( 10 )\end{matrix}$$

In this equation, i_{d}* is a d-axis current command. Although Equations (9) and (10) are based on the assumption that Pₘₒₜ=Pᵢₙ, the motor 314 is inevitably subjected to losses such as copper loss, iron loss, and mechanical loss. The computation may be performed also taking into account such losses.

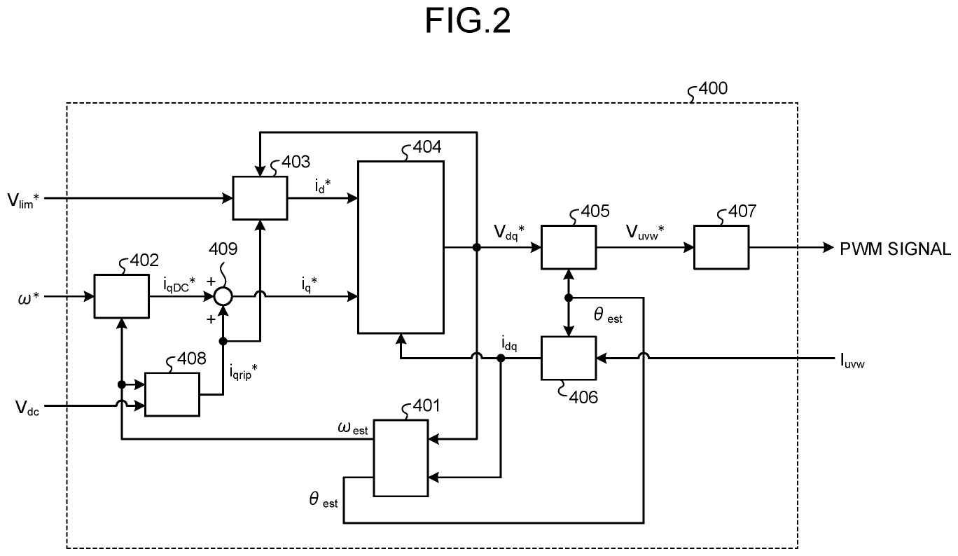

A configuration of the control unit 400 to perform the foregoing computation will next be described. FIG. 2 is a block diagram illustrating an example configuration of the control unit 400 of the power converting apparatus 1 according to the first embodiment. The control unit 400 includes a rotor position estimation unit 401, a speed control unit 402, a flux-weakening control unit 403, a current control unit 404, coordinate conversion units 405 and 406, a PWM signal generation unit 407, a q-axis current pulsation computing unit 408, and an addition unit 409.

The rotor position estimation unit 401 estimates an estimated phase angle θₑₛₜ and an estimated speed ωₑₛₜ of a rotor (not illustrated) of the motor 314, on the basis of a dq-axis current vector i_{dq} and a dq-axis voltage command vector V_{dq}* for the motor 314. The estimated phase angle θₑₛₜ is the direction of the rotor magnetic pole with respect to dq axes, and the estimated speed ωₑₛₜ is the rotor speed.

The speed control unit 402 generates a q-axis current command i_{DC}* from a speed command ω* and the estimated speed ωₑₛₜ. Specifically, the speed control unit 402 automatically adjusts the q-axis current command i_{qDc}* such that the speed command ω* matches the estimated speed ωₑₛₜ. When the power converting apparatus 1 is used as a refrigeration cycle-incorporating apparatus in an air conditioner or the like, the speed command ω* is based on, for example, a temperature detected by a temperature sensor (not illustrated), information representing a setting temperature indicated by a remote controller (not illustrated) serving as an operation unit, operation mode selection information, information on instructions for the start of operation and the termination of operation, and the like. Examples of the operation mode include heating, cooling, and dehumidification. The q-axis current command i_{qDC}* may be referred to hereinafter as first q-axis current command.

The flux-weakening control unit 403 automatically adjusts a d-axis current command i_{d}* such that the absolute value of the dq-axis voltage command vector V_{dq}* falls within a limitation value of a voltage limit value Vₗᵢₘ* In addition, in the present embodiment, the flux-weakening control unit 403 performs flux-weakening control, taking into consideration a q-axis current pulsation command i_{grip}* computed by the q-axis current pulsation computing unit 408. There are roughly two types of flux-weakening control: a method in which to calculate the d-axis current command i_{d}* from a voltage limit ellipse equation; and a method in which to calculate the d-axis current command i_{d}* such that a difference in absolute value between the voltage limit value Vₗᵢₘ* and the dq-axis voltage command vector V_{dq}* becomes zero. Either of these methods may be used. A specific configuration and operation of the flux-weakening control unit 403 will be described later.

The current control unit 404 controls the current flowing to the motor 314, using the q-axis current command i_{q}* and the d-axis current command i_{d}*, and generates the dq-axis voltage command vector V_{dq}*. Specifically, the current control unit 404 automatically adjusts the dq-axis voltage command vector V_{dq}* such that the dq-axis current vector i_{dq} follows the d-axis current command i_{d}* and the q-axis current command i_{q}*. The dq-axis voltage command vector V_{dq}* may be referred to hereinafter simply as dq-axis voltage command.

The coordinate conversion unit 405 performs coordinate transformation to convert the dq-axis voltage command vector V_{dq}* represented by dq coordinates, into a voltage command V_{uvw}* in AC amounts, in accordance with the estimated phase angle θₑₛₜ.

The coordinate conversion unit 406 performs coordinate transformation to convert a current I_{uvw} in AC amounts flowing to the motor 314, into the dq-axis current vector i_{dq} represented by dq coordinates, in accordance with the estimated phase angle θₑₛₜ. As described above, the current values of two phases among the current values of the three phases output from the inverter 310 are detected by the current detection units 313a and 313b, and the control unit 400 calculates the current value of the remaining one phase, using the current values of the two phases. From the detected current values and the calculated current value, the control unit 400 can obtain the current I_{uvw} flowing to the motor 314.

The PWM signal generation unit 407 generates a PWM signal on the basis of the voltage command V_{uvw}* obtained by coordinate transformation performed by the coordinate conversion unit 405. The control unit 400 applies a voltage to the motor 314 by outputting, to the switching elements 311a to 311f of the inverter 310, the PWM signal generated by the PWM signal generation unit 407.

The q-axis current pulsation computing unit 408 computes a q-axis current pulsation, using the detection values to thereby generate the foregoing q-axis current pulsation command i_{grip}*, i.e., the pulsatile component of the q-axis current command i_{q}*. Specifically, the q-axis current pulsation computing unit 408 calculates the q-axis current pulsation command i_{grip}* by performing computation of Equation (9) or Equation (10) on the basis of the estimated speed ωₑₛₜ and the DC bus voltage V_{dc}, i.e., the voltage value detected by the voltage detection unit 501. Because the pulsation amplitude of the q-axis current i_{q} varies depending on the condition of driving the motor 314, the q-axis current pulsation computing unit 408 determines the amplitude, taking into account appropriately the drive condition.

The addition unit 409 generates the q-axis current command i_{q}* by adding together the q-axis current command i_{qDC}* output from the speed control unit 402 and the q-axis current pulsation command i_{grip}* computed by the q-axis current pulsation computing unit 408, and outputs the q-axis current command i_{q}* to the current control unit 404. The q-axis current command i_{q}* may be referred to hereinafter as second q-axis current command.

The control unit 400 differs from a power converting apparatus that provides control similar to conventional control in that: the control unit 400 computes the q-axis current pulsation command i_{grip}* according to Equation (9) or Equation (10), and then computes the q-axis current command i_{q}* using the q-axis current pulsation command i_{grip}*; and the control unit 400 performs flux-weakening control taking into account the q-axis current pulsation command i_{grip}*. An application such as an air conditioning compressor motor actively utilizes flux-weakening control, inverter overmodulation, and/or the like. Such types of control are used in a voltage saturation range, in which range the voltage fails to follow the command value because of voltage insufficiency even when the q-axis current i_{q} is provided with a pulsation. To address this, it is required that not only the q-axis current i_{q} but also the d-axis current i_{d} pulsate according to the q-axis current pulsation command i_{grip}*. A known method of flux-weakening control allows the d-axis current i_{d} to pulsate concurrently with the q-axis current i_{q} so as to keep the voltage amplitude constant. The flux-weakening control unit 403 causes the d-axis current is to pulsate concurrently with the q-axis current pulsation command i_{grip}* under a condition of voltage saturation to thereby prevent the voltage insufficiency.

With the q-axis current pulsation computing unit 408, the control unit 400 appropriately provides the motor 314 with a pulsation such that the current flowing to the capacitor 210 approaches zero or becomes a low value, thereby reducing the flow of current to and from the capacitor 210, i.e., the charge-discharge current I3 of the capacitor 210.

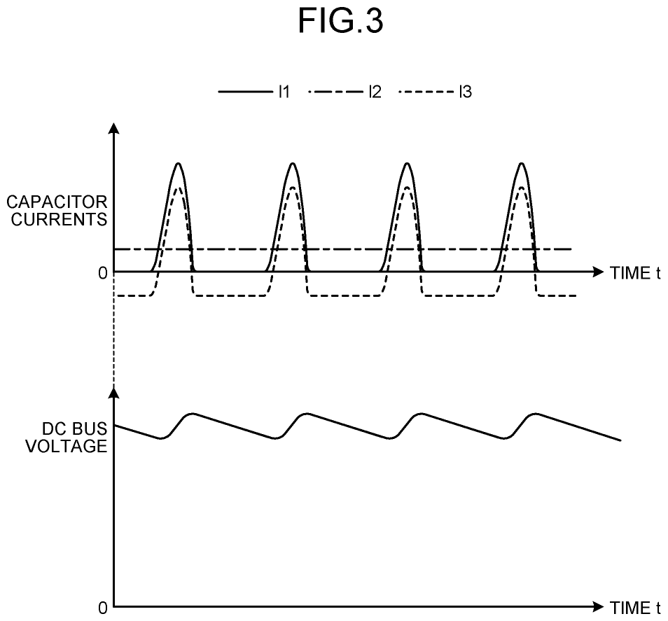

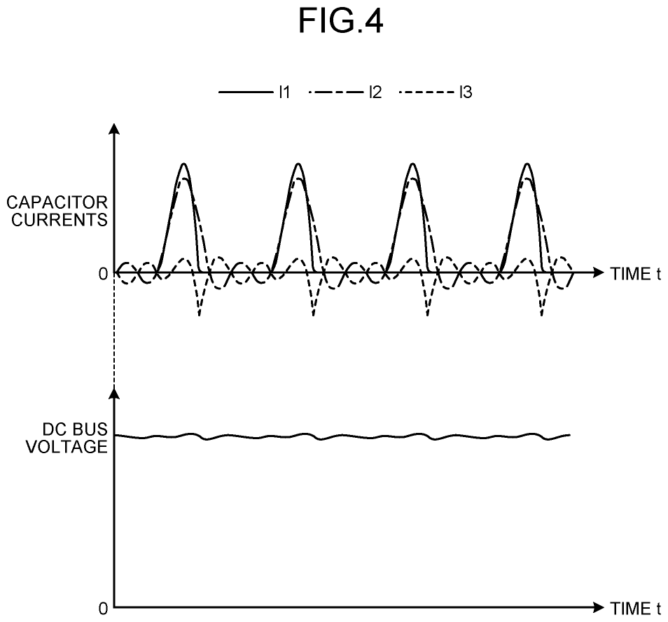

FIG. 3 is a diagram illustrating, as a comparative example, an example of drive waveform provided by a power converting apparatus having a circuit configuration similar to the circuit configuration of the power converting apparatus 1 of the first embodiment. Assume that the power converting apparatus of the comparative example shown in FIG. 3 provides no control such as one provided by the power converting apparatus 1 of the present embodiment. FIG. 4 is a diagram illustrating an example of drive waveform provided by the power converting apparatus 1 according to the first embodiment. In FIGS. 3 and 4, the upper graph illustrates the input current I1 from the rectifier unit 130 to the capacitor 210, the output current I₂ from the capacitor 210, and the charge-discharge current I3 of the capacitor 210, and the lower graph illustrates the DC bus voltage V_{dc}. Note that FIGS. 3 and 4 use the same scale for illustration. In addition, for convenience of illustration, the PWM ripple is not taken into account in FIGS. 3 and 4.

When the capacitor 210 of the smoothing unit 200 has a capacity high to a certain degree, the input current I1 flowing into the capacitor 210 has a form resembling a “rabbit ear”. For the power converting apparatus of the comparative example, the charge-discharge current I3 of the capacitor also has a form of a “rabbit ear” because the output current I₂ from the capacitor is almost constant. This generates a large ripple in the DC bus voltage V_{dc}. These waveforms include a large periodic pulsation, which accelerates aging degradation of the capacitor 210.

For the power converting apparatus 1 of the present embodiment, in contrast, the control unit 400 controls the operation of the inverter 310 such that the output current I₂ from the capacitor 210 has a form of a “rabbit ear”, thereby reducing the peak value of the charge-discharge current I3 of the capacitor 210. When the peak value of the charge-discharge current I3 of the capacitor 210 is reduced, the ripple of the DC bus voltage V_{dc} is also reduced. Reduction of the flow of current to and from the capacitor 210 enables the reduction of element degradation, and the reduction of aging degradation of components. As the control unit 400 allows for the foregoing reduction, the power converting apparatus 1 reduces the capacity of the element accordingly, which mitigates a resistance to ripple. For this reason, it becomes possible to utilize a low-cost smoothing element, i.e., the capacitor 210, and thus reduce an incurring system cost. Note that FIG. 4 illustrates the waveform with only the DC component, the power supply frequency 2f component, and the power supply frequency 4f component extracted under degradation reducing control. Meanwhile, higher-order components may also be taken into account to further reduce the charge-discharge current I3 of the capacitor 210. In doing so, it is necessary and sufficient in practice to take into consideration up to the power supply frequency 6f. Only the DC component and the power supply frequency 2f component are taken into account for the purpose of reducing the amount of calculation.

Because the control method carried out by the control unit 400 according to the present embodiment is based on a theoretical equation for the power input to and output from the motor 314. Such a control method can directly determine the q-axis current pulsation for the motor 314 in response to a change in the input current I1, and thus provide high promptness relative to a change in the input current I1. For this reason, the control method has an advantage of making it easy to reduce the degradation of the capacitor 210 of the smoothing unit 200 when pulsation load compensation is performed together with the control method.

Note that when the motor 314 drives the compressor 315 that is a load having a periodic load torque pulsation, as illustrated in FIG. 1, the control unit 400 may control the load in combination with the foregoing control in such a manner as to reduce speed pulsation caused by the load torque pulsation.

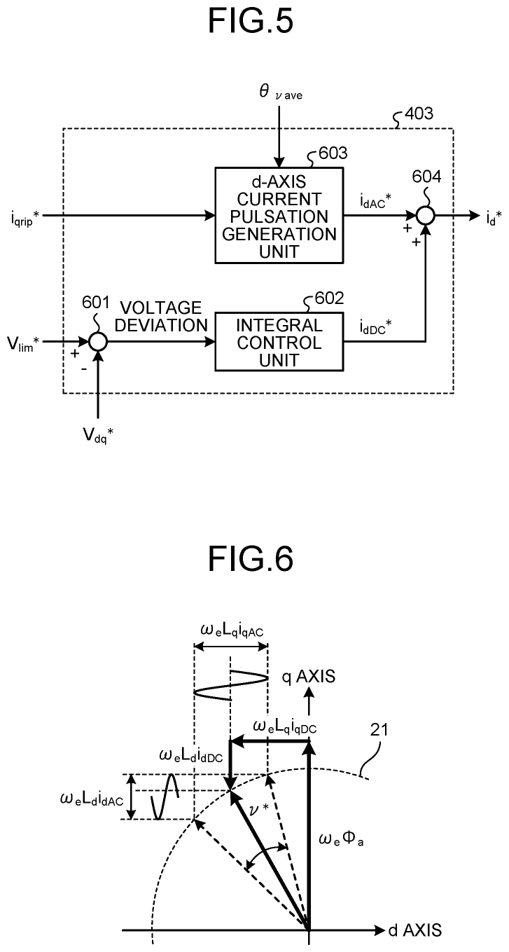

A configuration and an operation of the flux-weakening control unit 403 will next be described. FIG. 5 is a block diagram illustrating an example configuration of the flux-weakening control unit 403 of the control unit 400 of the power converting apparatus 1 according to the first embodiment. The flux-weakening control unit 403 includes a subtraction unit 601, an integral control unit 602, a d-axis current pulsation generation unit 603, and an addition unit 604.

The subtraction unit 601 performs the subtraction operation of calculating the voltage deviation by subtracting the dq-axis voltage command vector V_{dq}* from the voltage limit value Vₗᵢₘ*.

The integral control unit 602 determines a d-axis current command i_{dDC}*, performing integral control such that the voltage deviation calculated by the subtraction unit 601 becomes zero. Note that the flux-weakening control unit 403 may perform proportional control, derivative control, and/or the like in parallel with the integral control performed by the integral control unit 602. That is, the flux-weakening control unit 403 may include a proportional integral differential (PID) control unit in place of the integral control unit 602. In case of occurrence of voltage insufficiency during driving of the motor 314, the power converting apparatus 1 can reduce the voltage insufficiency because the flux-weakening control unit 403 automatically increases the d-axis current i_{d}. The d-axis current command i_{dDC}* may be referred to hereinafter as first d-axis current command.

Typical flux-weakening control, which does not use motor parameters, is robust with respect to parameter variation. Unfortunately, such flux-weakening control is disadvantageous in failing to provide high control responsiveness. This is because the attempt to forcedly increase control response may cause control instability. For this reason, the d-axis current i_{d} is maintained at an almost constant value even when the q-axis current i_{q} fluctuates at a high frequency. In this case, a power converting apparatus that performs typical flux-weakening control is set carrying the d-axis current i_{d} in excess because of occurrence of transient voltage insufficiency. This results in an increase in copper loss. In view of this, in the present embodiment, the power converting apparatus 1 also causes the d-axis current i_{d} to pulsate in synchronization with the q-axis current pulsation.

The d-axis current pulsation generation unit 603 calculates a d-axis current pulsation command i_{dAc}*, using the q-axis current pulsation command i_{grip}* obtained from the q-axis current pulsation computing unit 408 and an average value θᵥₐᵥₑ of the voltage phase. The d-axis current pulsation generation unit 603 generates the d-axis current pulsation command i_{dAc}* for reducing increase and decrease in the amplitude of the dq-axis voltage command vector V_{dq}* caused by the q-axis current pulsation command i_{grip}* corresponding to the q-axis current pulsation, the d-axis current pulsation command i_{dAc}* being synchronized with the q-axis current pulsation command i_{grip}*. The average value θᵥₐᵥₑ of the voltage phase can be obtained by computation from the absolute value of the dq-axis voltage command vector V_{dq}*. The average value θᵥₐᵥₑ of the voltage phase may be computed by a component outside the flux-weakening control unit 403 or by the d-axis current pulsation generation unit 603 or an unillustrated component inside the flux-weakening control unit 403. Note that the method for calculating the d-axis current pulsation command i_{dAc}* performed in the d-axis current pulsation generation unit 603 is not limited to the example described above. When the flux-weakening control unit 403 takes the d-axis current command i_{dDC}* output from the integral control unit 602, as a low-frequency d-axis current command, the d-axis current pulsation generation unit 603 determines the d-axis current pulsation command i_{dAc}* as a high-frequency d-axis current pulsation command.

The addition unit 604 determines the d-axis current command i_{d}* by adding together two command values, i.e., the d-axis current command i_{dDC}* obtained by the integral control unit 602 and the d-axis current pulsation command i_{dAc}* obtained by the d-axis current pulsation generation unit 603. The d-axis current command i_{d}* may be referred to hereinafter as second d-axis current command.

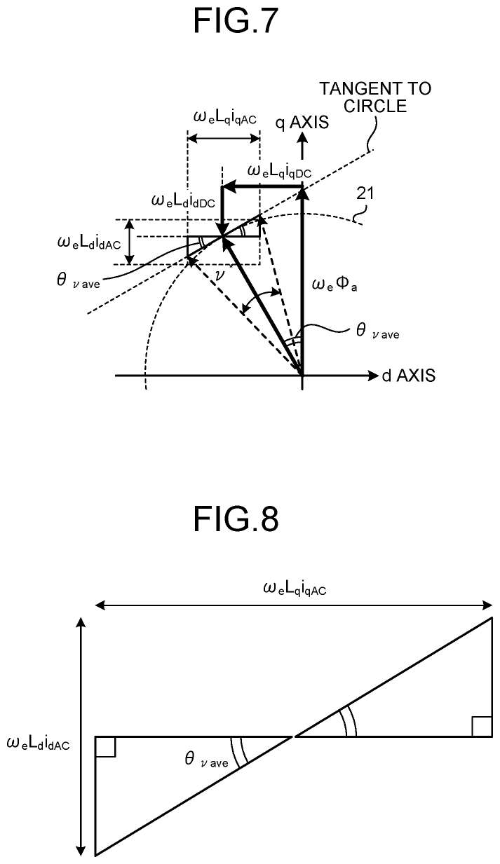

As described above, the flux-weakening control unit 403 generates the d-axis current pulsation command i_{dAc}* causing the d-axis current is to pulsate in synchronization with the q-axis current pulsation command i_{grip}*. The flux-weakening control unit 403 generates, from the voltage deviation between the dq-axis voltage command vector V_{dq}* and the voltage limit value Vₗᵢₘ*, the d-axis current command i_{dDC}* having a frequency lower than the frequency of the d-axis current pulsation command i_{dAc}*. The flux-weakening control unit 403 adds together the d-axis current command i_{dDC}* and the d-axis current pulsation command i_{dAc}* to generate the d-axis current command i_{d}*. A principle of the flux-weakening control in the flux-weakening control unit 403 of the present embodiment will now be described. FIG. 6 is a diagram illustrating a voltage command v* when flux-weakening control is performed by the flux-weakening control unit 403 of the control unit 400 of the power converting apparatus 1 according to the first embodiment. FIG. 7 is a first diagram illustrating a simple method for the flux-weakening control unit 403 according to the first embodiment to calculate a d-axis current pulsation i_{dAc}. FIG. 8 is a second diagram illustrating the simple method for the flux-weakening control unit 403 according to the first embodiment to calculate the d-axis current pulsation i_{dAC}. In the description as to FIGS. 6 to 8, the voltage command v* corresponds to the foregoing dq-axis voltage command vector V_{dq}*. The limit value Vₒₘ corresponds to the foregoing voltage limit value Vₗᵢₘ*. In addition, the d-axis current pulsation i_{dAC} corresponds to the foregoing d-axis current pulsation command i_{dAC}*. The d-axis current i_{dDC} corresponds to the foregoing d-axis current command i_{dDC}*. The q-axis current pulsation i_{qAC} corresponds to the foregoing q-axis current pulsation command i_{grip}*. The q-axis current i_{qDc} corresponds to the foregoing q-axis current command i_{qDC}*.

The limit value Vₒₘ forms a hexagonal shape in a strict sense, but the shape of the limit value Vₒₘ is herein approximated to a circle in a dq-coordinate system. Although the description of the present embodiment is based on the assumption that the limit value Vₒₘ is represented by a circle by approximation, but, as a matter of course, the description can be made taking the limit value Vₒₘ as forming the hexagonal shape in a strict sense. In the present embodiment, a circle having a radius of the limit value Vₒₘ about the origin is referred to as voltage limit circle 21. Note that the limit value Vₒₘ varies depending on the value of the DC bus voltage Var. In FIG. 6, the voltage command v* is determined by factors such as the d-axis current i_{d}, the q-axis current i_{q}, the motor speed, and motor parameters. In addition, the voltage command v* is limited by the voltage limit circle 21. When the control unit 400 of the power converting apparatus 1 adds the q-axis current pulsation i_{qAC} to the q-axis current i_{q} during overmodulation, the voltage command v* will exceed the voltage limit range, i.e., the voltage limit circle 21 unless the control unit 400 adds the d-axis current pulsation i_{dAC} to the d-axis current i_{d}. In view of this, the flux-weakening control unit 403 of the control unit 400 of the power converting apparatus 1 in the present embodiment adds the d-axis current pulsation i_{dAc} to the d-axis current i_{d} to thereby prevent voltage insufficiency.

There are various possible methods for calculating the d-axis current pulsation i_{dAC}. One such method is, as described in Patent Literature 1, an approximation technique using a line tangent to the voltage limit circle 21. Consider a voltage locus obtained with the q-axis current pulsation i_{qAC} given where the average value of the voltage phase is denoted by θᵥₐᵥₑ. The voltage locus extending in the tangential direction of the voltage limit circle 21 is on a right triangle as illustrated in FIG. 8, and θᵥₐᵥₑ is one of the angles of the right triangle. Using this, the d-axis current pulsation generation unit 603 of the flux-weakening control unit 403 computes the d-axis current pulsation i_{dAc}, i.e., the d-axis current pulsation command i_{dAC}*, as shown by Equation (11).

$$\begin{matrix}Formula 11 & \\ {i}_{dAC}^{*} = - {i}_{qAC}^{*} \frac{{L}_{q}}{{L}_{d}} tan ( {θ}_{vave} ) & ( 11 )\end{matrix}$$

That is, the flux-weakening control unit 403 generates the d-axis current pulsation command i_{dAc}* on the basis of a result of multiplication of the tangent of the average value of the angular advance of voltage by the q-axis current pulsation command i_{grip}*. In other words, the flux-weakening control unit 403 generates the d-axis current pulsation command i_{dAC}* in such a manner as to keep the locus of the voltage command v* extending in the circumferential direction or the tangential direction of the voltage limit circle 21, the locus of the voltage command v* being the vector of the dq-axis voltage command, the voltage limit circle 21 having a specified radius based on the voltage limit value Vₗᵢₘ*. The flux-weakening control unit 403 includes the d-axis current pulsation generation unit 603 calculating the d-axis current pulsation command i_{dAC}* as shown by Equation (11) and determines the d-axis current command i_{d}*, using the d-axis current pulsation command i_{dAc}*. This enables the power converting apparatus 1 to keep the voltage command amplitude constant even under the capacitor current reducing control. The power converting apparatus 1 eliminates the need to carry an excessive amount of the d-axis current is, and hence can effectively reduce the capacitor current in an overmodulation range.

As described above, the control unit 400 superimposes the q-axis current pulsation command i_{grip}* corresponding to the q-axis current pulsation on the drive pattern of the motor 314 in accordance with the detection value of a detection unit, the q-axis current pulsation command i_{grip}* corresponding to the q-axis current pulsation. The control unit 400 thus reduces the charge-discharge current I3 of the capacitor 210 and causes the d-axis current i_{d} of the motor 314 to pulsate in synchronization with the frequency of the q-axis current pulsation command i_{grip}* during the saturation of the voltage of the inverter 310, the q-axis current pulsation command i_{grip} corresponding to the q-axis current pulsation. Note that the q-axis current i_{q} can be expressed as an active current, and the d-axis current i_{d} can be expressed as a reactive current. Similar notation also applies to the following description.

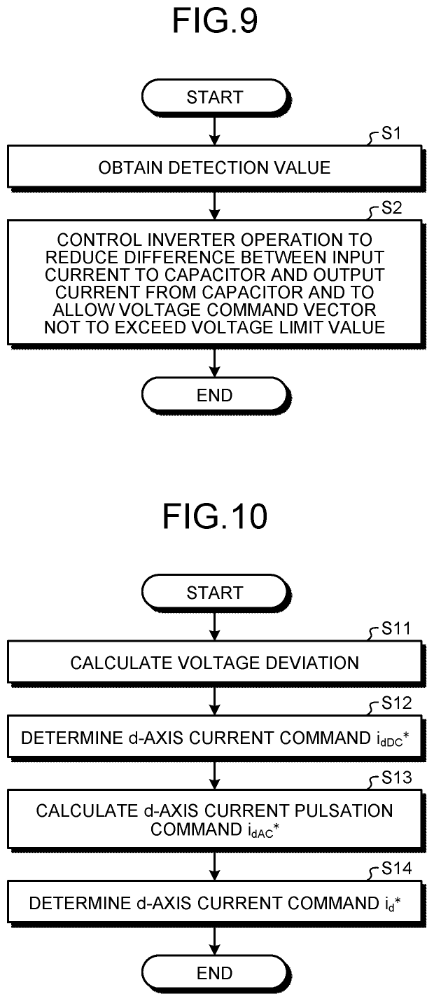

An operation of the control unit 400 will next be described using a flowchart. FIG. 9 is a flowchart illustrating an operation of the control unit 400 of the power converting apparatus 1 according to the first embodiment. The control unit 400 obtains the DC bus voltage V_{dc} of the capacitor 210, which is a detection value, from the voltage detection unit 501 (step S1). The control unit 400 controls, on the basis of the detection value obtained, the operation of the inverter 310 to reduce the difference between the input current I1 to the capacitor 210 and the output current I₂ from the capacitor 210, and to allow the dq-axis voltage command vector V_{dq}* not to exceed the voltage limit value Vₗᵢₘ* (step S2).

FIG. 10 is a flowchart illustrating an operation of the flux-weakening control unit 403 of the control unit 400 of the power converting apparatus 1 according to the first embodiment. In the flux-weakening control unit 403, the subtraction unit 601 subtracts the dq-axis voltage command vector V_{dq}* from the voltage limit value Vₗᵢₘ* to calculate the voltage deviation (step S11). The integral control unit 602 performs integral control to bring the voltage deviation to zero and determines the d-axis current command i_{dDC}* (step S12). The d-axis current pulsation generation unit 603 calculates the d-axis current pulsation command i_{dAc}*, using the q-axis current pulsation command i_{grip}* and the average value θᵥₐᵥₑ of the voltage phase (step S13). The addition unit 604 adds together the d-axis current command i_{dDc}* and the d-axis current pulsation command i_{dAc}* to generate the d-axis current command i_{d}*, that is, to determine the d-axis current command i_{d}* (step S14).

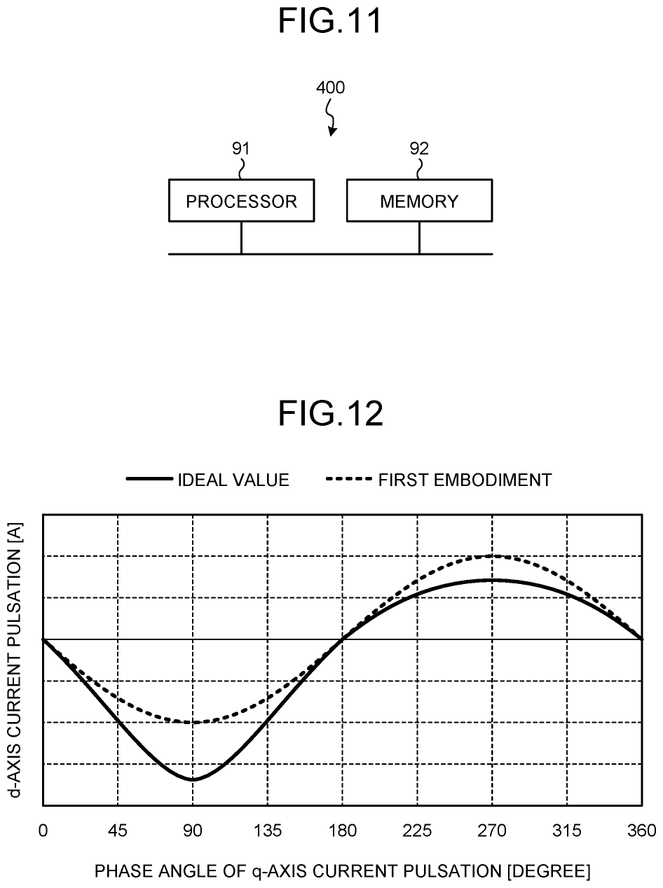

A hardware configuration of the control unit 400 included in the power converting apparatus 1 will next be described. FIG. 11 is a diagram illustrating an example of hardware configuration for implementing the control unit 400 included in the power converting apparatus 1 according to the first embodiment. The control unit 400 is implemented by a combination of a processor 91 and a memory 92.

The processor 91 is a central processing unit (CPU) (also known as a processing unit, a computing unit, a microprocessor, a microcomputer, a processor, and a digital signal processor (DSP)) or a system large scale integration (LSI). The memory 92 may be, for example, a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark). In addition, the memory 92 is not limited to these, and may also be a magnetic disk, an optical disk, a compact disc, a MiniDisc, or a digital versatile disc (DVD).

As described above, according to the present embodiment, the control unit 400 in the power converting apparatus 1 computes the q-axis current pulsation command i_{grip}*, using the DC bus voltage V_{dc} of the capacitor 210 detected by the voltage detection unit 501, generates the d-axis current command i_{d}*, using the q-axis current pulsation command i_{grip}* to control the operation of the inverter 310, and thus reduces the charge-discharge current 13 of the capacitor 210. This can reduce increase in size of the power converting apparatus 1 and reduce degradation of the smoothing capacitor 210 as well. The power converting apparatus 1 can also reduce a decrease in efficiency in an overmodulation range.

### Second Embodiment

Although, in the first embodiment, the d-axis current pulsation i_{dAc} is obtained such that the locus of the vector of the voltage command v* becomes the line tangent to the voltage limit circle 21, an ideal preferable locus is a circular locus. A large q-axis current pulsation i_{qAC} may cause a large error between a value on an approximate tangent and an ideal value, thereby making it unlikely to perform reasonable flux-weakening control. FIG. 12 is a diagram illustrating a control error in the flux-weakening control performed by the flux-weakening control unit 403 of the control unit 400 of the power converting apparatus 1 according to the first embodiment. In FIG. 12, the horizontal axis represents the phase angle of the q-axis current pulsation i_{qAC}, and the vertical axis represents the d-axis current pulsation i_{dAC}. Although FIG. 12 illustrates an estimation made under a condition that the q-axis current pulsation i_{qAC} has an amplitude large to a certain degree, the d-axis current pulsation i_{dAc} required to make the voltage command amplitude constant has a waveform such as one depicted by the solid line of FIG. 12.

The waveform of the d-axis current pulsation i_{dAC} oscillates with generally the same period as the period of the q-axis current pulsation i_{qAC}, but includes some harmonic components. The waveform depicted by this solid line represents an ideal value in the control, while the actual d-axis current pulsation i_{dAC} output by the flux-weakening control unit 403 has the waveform of the dotted line of FIG. 12. The flux-weakening control unit 403 of the first embodiment is intended to provide a sinusoidal waveform without harmonics, which results in some deviation from the ideal value. Such deviation is negligible for a small q-axis current pulsation i_{qAC}, but is hard to neglect for a large q-axis current pulsation i_{qAC}. Because of occurrence of such control error in the flux-weakening control unit 403 of the first embodiment, a large q-axis current pulsation i_{qAC} may cause various disadvantages such as a speed pulsation, a reduction in the capacitor current or the like, and an increase in copper loss. Thus, the present embodiment will be described as to a method for reducing or preventing an occurrence of a control error in the flux-weakening control.

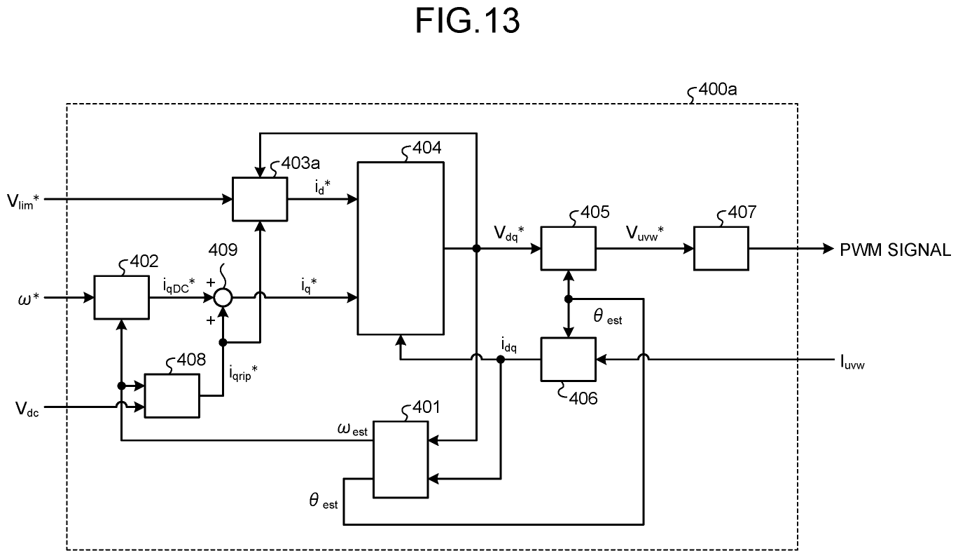

FIG. 13 is a block diagram illustrating an example configuration of a control unit 400a of the power converting apparatus 1 according to a second embodiment. The control unit 400a includes a flux-weakening control unit 403a in place of the flux-weakening control unit 403 as compared to the control unit 400 of the first embodiment illustrated in FIG. 2. Note that although not illustrated, the power converting apparatus 1 according to the second embodiment includes the control unit 400a in place of the control unit 400 as compared to the power converting apparatus 1 of the first embodiment illustrated in FIG. 1.

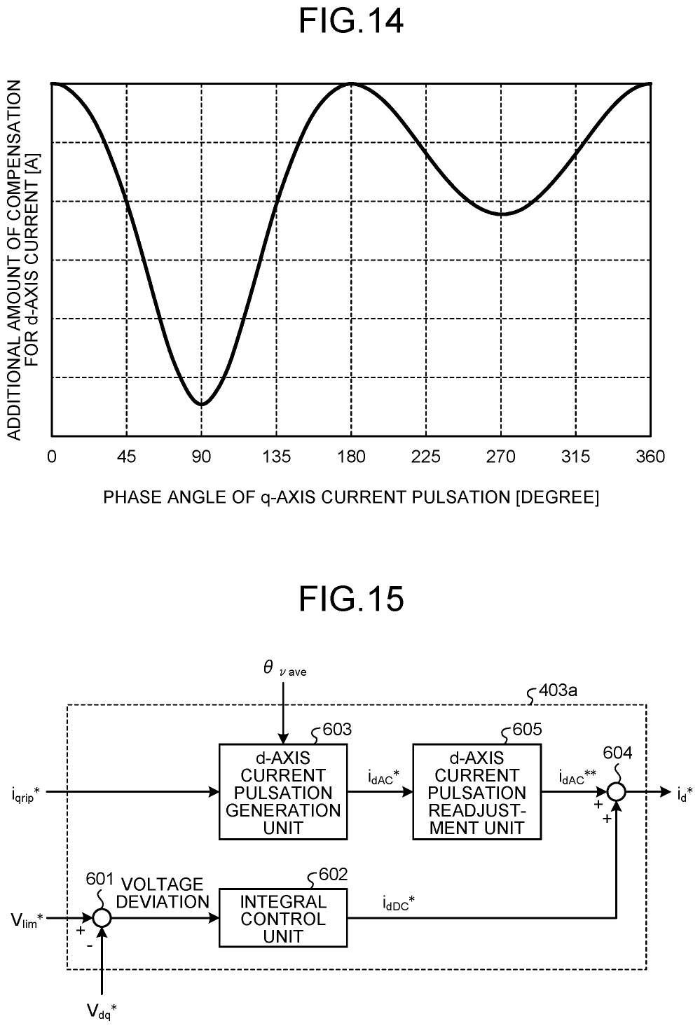

FIG. 14 is a diagram illustrating a control error in the flux-weakening control performed by the flux-weakening control unit 403a of the control unit 400a of the power converting apparatus 1 according to the second embodiment. In FIG. 14, the horizontal axis represents the phase angle of the q-axis current pulsation i_{qAC}, and the vertical axis represents an additional amount of compensation for the d-axis current. The waveform illustrated in FIG. 14 represents the difference between the waveform of the solid line and the waveform of the dotted line illustrated in FIG. 12. Note that FIG. 14 is depicted on an enlarged scale along the vertical axis relative to FIG. 12. The flux-weakening control unit 403a of the second embodiment is capable of providing ideal flux-weakening control by calculating a current waveform such as one illustrated in FIG. 14, and adding that current waveform to the d-axis current pulsation i_{dAC}.

A configuration and operation of the flux-weakening control unit 403a will next be described. FIG. 15 is a block diagram illustrating an example configuration of the flux-weakening control unit 403a of the control unit 400a of the power converting apparatus 1 according to the second embodiment. The flux-weakening control unit 403a additionally includes a d-axis current pulsation readjustment unit 605 as compared to the flux-weakening control unit 403 of the first embodiment illustrated in FIG. 5.

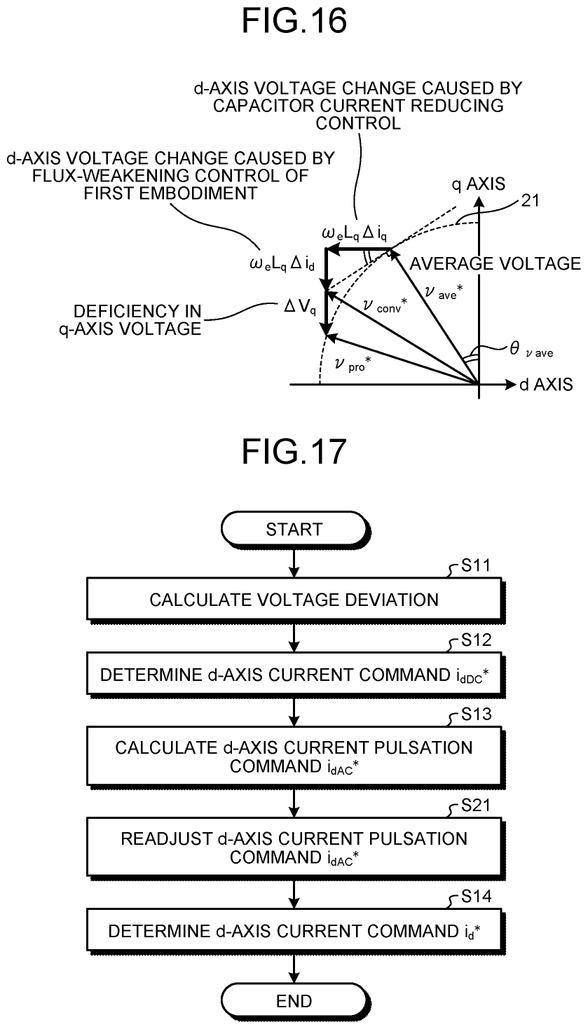

The d-axis current pulsation readjustment unit 605 examines the amount of increase and decrease in the amplitude of the dq-axis voltage command vector V_{dq}* caused by the q-axis current pulsation command i_{grip}* and the d-axis current pulsation command i_{dAc}*, readjusts the d-axis current pulsation command i_{dAC}* in accordance with the amount of increase and decrease, and outputs the readjusted d-axis current pulsation command i_{dAC}**. Specifically, the d-axis current pulsation readjustment unit 605 calculates the additional amount of compensation for the d-axis current is in the following process. FIG. 16 is a diagram for describing the flux-weakening control performed by the flux-weakening control unit 403a of the control unit 400a of the power converting apparatus 1 according to the second embodiment. Let v*ₐᵥₑ denote the average voltage command, and v*_{conv} denote the voltage command generated under the flux-weakening control of the first embodiment. Because the voltage command v*_{conv} is likely to exceed the voltage limit circle 21, the q-axis voltage will be short by a deficiency ΔV_{q}. When a value of the deficiency ΔV_{q} in the q-axis voltage is known, the value of Δi_{d2}, which is the additional amount of compensation for the d-axis current i_{d}, can be obtained as shown by Equation (12) below.

$$\begin{matrix}Formula 12 & \\ Δ {i}_{d 2} = \frac{Δ {V}_{q}}{{ω}_{e} {L}_{d}} & ( 12 )\end{matrix}$$

A dq-axis flux linkage Φₐ caused by the permanent magnet is desirably known to accurately calculate the deficiency ΔV_{q} in the q-axis voltage. In view of the dependence of the dq-axis flux linkage Φₐ on the motor temperature, however, the deficiency ΔV_{q} is estimated without using the dq-axis flux linkage Φₐ, as discussed below. The voltage command v*_{conv} in the first embodiment includes a d-axis voltage component v*_{dconv} and a q-axis voltage component v*_{qconv} expressed by Equations (13) and (14).

$$\begin{matrix}Formula 13 & \\ {v}_{dconv}^{*} = \vert {v}_{ave}^{*} \vert sin ( {θ}_{vave} ) - {ω}_{e} {L}_{q} Δ {i}_{q} & ( 13 )\end{matrix}$$

$$\begin{matrix}Formula 14 & \\ {v}_{qconv}^{*} = \vert {v}_{ave}^{*} \vert cos ( {θ}_{vave} ) - {ω}_{e} {L}_{q} Δ {i}_{q} & ( 14 )\end{matrix}$$

The limit value V_{qlim} of the q-axis voltage is obtained by the Pythagorean theorem as shown by Equation (15) with the d-axis voltage component v*_{dconv} and the voltage limit circle 21 having a radius of the limit value Vₒₘ in the first embodiment.

$$\begin{matrix}Formula 15 & \\ {v}_{qlim} = \sqrt{{( {V}_{om} )}^{2} - {( {v}_{dconv}^{*} )}^{2}} & ( 15 )\end{matrix}$$

The limit value Vₒₘ and the DC bus voltage V_{dc} have a relationship as shown by Equation (16) below in general. However, when overmodulation is performed on the inverter 310, the relationship is not limited thereto, and thus another ratio may be used.

$$\begin{matrix}Formula 16 & \\ {V}_{om} ≅ \frac{{V}_{d c}}{\sqrt{2}} & ( 16 )\end{matrix}$$

Calculation of a difference between the q-axis voltage component v*_{qconv} in the first embodiment and the limit value V_{qlim} of the q-axis voltage provides the deficiency ΔV_{q} in the q-axis voltage as shown by Equation (17). The d-axis current pulsation readjustment unit 605 thus readjusts the d-axis current pulsation command i_{dAc}* using such computation.

$$\begin{matrix}Formula 17 & \\ Δ {V}_{q} = {V}_{qlim} - {v}_{qconv}^{*} & ( 17 )\end{matrix}$$

FIG. 17 is a flowchart illustrating an operation of the flux-weakening control unit 403a of the control unit 400a of the power converting apparatus 1 according to the second embodiment. In the flux-weakening control unit 403a, the subtraction unit 601 subtracts the dq-axis voltage command vector V_{dq}* from the voltage limit value Vₗᵢₘ* to calculate the voltage deviation (step S11). The integral control unit 602 performs integral control to bring the voltage deviation to zero and determines the d-axis current command i_{dDC}* (step S12). The d-axis current pulsation generation unit 603 calculates the d-axis current pulsation command i_{dAC}*, using the q-axis current pulsation command i_{grip}* and the average value θᵥₐᵥₑ of the voltage phase (step S13). The d-axis current pulsation readjustment unit 605 readjusts the d-axis current pulsation command i_{dAc}* in accordance with the amount of increase and decrease in the voltage command amplitude caused by the dq-axis current pulsations (step S21). The addition unit 604 adds together the d-axis current command i_{dDC}* and the d-axis current pulsation command i_{dAC}** obtained by readjustment to generate the d-axis current command i_{d}*, that is, to determine the d-axis current command i_{d}* (step S14).

A hardware configuration of the control unit 400a included in the power converting apparatus 1 will next be described. Similarly to the control unit 400 in the first embodiment, the control unit 400a is implemented by a combination of the processor 91 and the memory 92.

As described above, according to the present embodiment, the flux-weakening control unit 403a of the control unit 400a in the power converting apparatus 1 readjusts the d-axis current pulsation command i_{dAc}* to determine the d-axis current command i_{d}*. Thus, the power converting apparatus 1 improves accuracy of flux-weakening control as compared to the first embodiment, and thus performs suitable flux-weakening control. This eliminates the need for the power converting apparatus 1 to carry an excess amount of the d-axis current i_{d}, thereby improving copper loss. The power converting apparatus 1 can reduce a decrease in efficiency in the overmodulation range as well as further reducing degradation of the smoothing capacitor 210 as compared to the first embodiment.

### Third Embodiment

The description of the flux-weakening control in the first embodiment and in the second embodiment is based on the flux-weakening control of Patent Literature 1. However, there are other conceivable methods for obtaining an appropriate d-axis current pulsation i_{dAC}. For example, a feedback-based method is also possible to obtain an appropriate d-axis current pulsation i_{dAC}. Unlike the techniques of the first embodiment and the second embodiment, a feedback-based technique requires complex control design, but is advantageous in being less susceptible to variation in a controlling constant, insufficiency in current control response, and the like. Known vibration reducing control techniques include techniques based on iterative control, Fourier coefficient calculation, and the like. Applying these techniques to feedback-based flux-weakening control will yield a good d-axis current pulsation i_{dAc}.

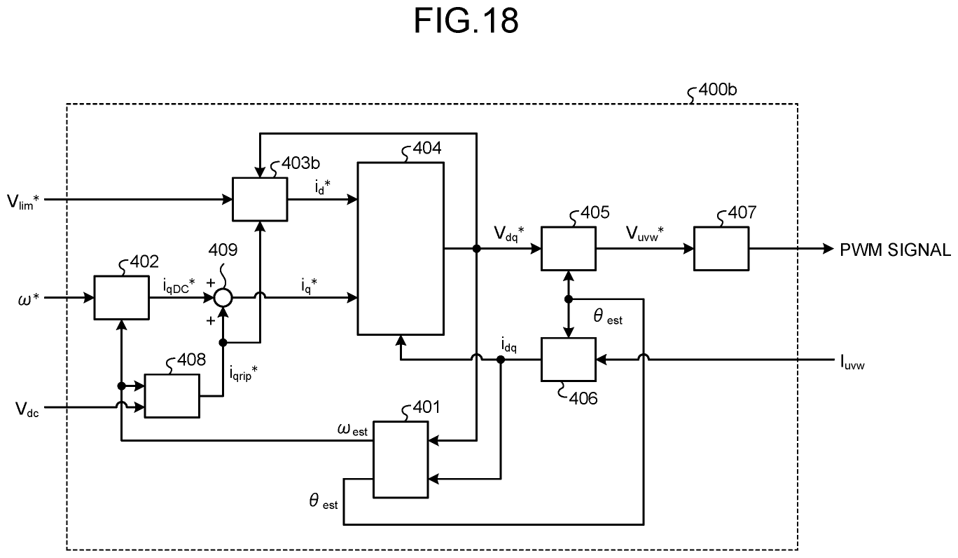

FIG. 18 is a block diagram illustrating an example configuration of a control unit 400b of the power converting apparatus 1 according to a third embodiment. The control unit 400b includes a flux-weakening control unit 403b in place of the flux-weakening control unit 403 as compared to the control unit 400 of the first embodiment illustrated in FIG. 2. Note that although not illustrated, the power converting apparatus 1 according to the third embodiment includes the control unit 400b in place of the control unit 400 as compared to the power converting apparatus 1 of the first embodiment illustrated in FIG. 1.

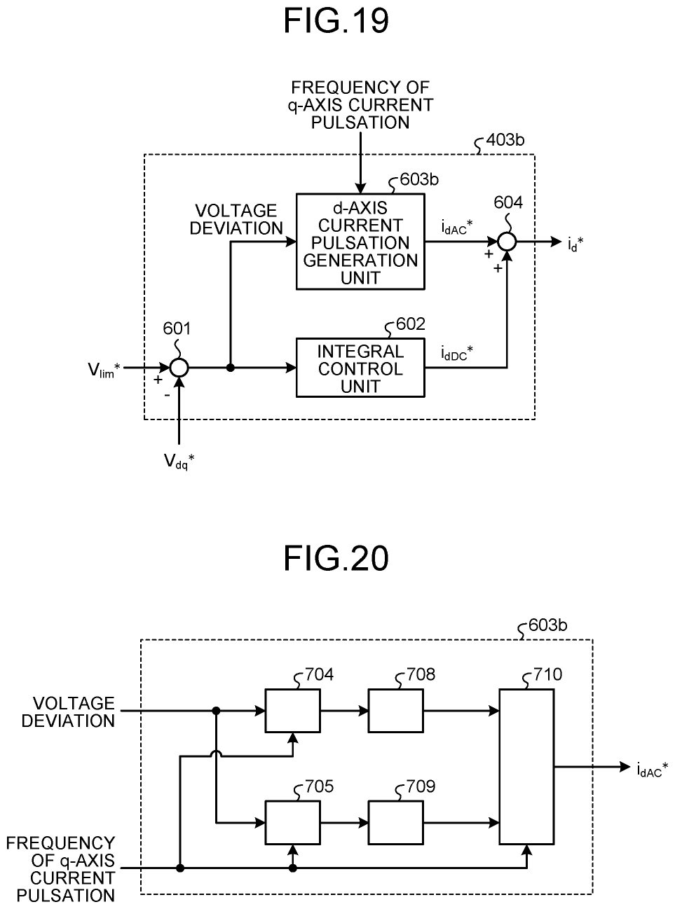

A configuration and operation of the flux-weakening control unit 403b will next be described. FIG. 19 is a block diagram illustrating an example configuration of the flux-weakening control unit 403b of the control unit 400b of the power converting apparatus 1 according to the third embodiment. The flux-weakening control unit 403b includes a d-axis current pulsation generation unit 603b in place of the d-axis current pulsation generation unit 603 as compared to the flux-weakening control unit 403 of the first embodiment illustrated in FIG. 5.

The d-axis current pulsation generation unit 603b generates, depending on the voltage deviation, the d-axis current pulsation command i_{dAc}* for reducing increase and decrease in the amplitude of the dq-axis voltage command vector V_{dq}*. Specifically, the d-axis current pulsation generation unit 603b computes the d-axis current pulsation command i_{dAc}* from the frequency of the q-axis current pulsation and the voltage deviation obtained by the subtraction unit 601. The frequency of the q-axis current pulsation is, for example, the q-axis current pulsation command i_{grip}* computed by the q-axis current pulsation computing unit 408. FIG. 20 is a block diagram illustrating an example configuration of the d-axis current pulsation generation unit 603b according to the third embodiment. The d-axis current pulsation generation unit 603b includes Fourier coefficient computing units 704 and 705, PID control units 708 and 709, and an AC restoration unit 710. The d-axis current pulsation generation unit 603b is configured to compute the d-axis current pulsation i_{dAc} from the voltage deviation. The technique used in the d-axis current pulsation generation unit 603b is a technique for providing control using Fourier coefficient calculation to convert the pulsation signal into DC components.

The Fourier coefficient computing units 704 and 705 extract a COS component and a SIN component separately as DC components, of a specific frequency component of the voltage deviation through Fourier coefficient calculation. For example, one of the Fourier coefficient computing units 704 and 705 extracts a COS 1F component, and the other extracts a SIN 1F component, where the frequency of the q-axis current pulsation is the basic frequency, that is, the frequency of the q-axis current pulsation is 1F. Since it is seen from FIG. 12 that the addition of a pulsation of the same frequency as the frequency of the q-axis current i_{q} to the d-axis current i_{d} is most effective, a control system that reduces the voltage deviation pulsation at the frequency 1F is described herein by way of example. However, the control system may be configured to reduce another frequency component. As described above, the Fourier coefficient computing units 704 and 705 extract, from the voltage deviation, a SIN component and a COS component separately as DC components, of a specified frequency component based on the q-axis current pulsation command i_{grip}*. The symbols SIN and COS may be hereinafter described as sine and cosine, respectively.

The PID control unit 708 performs PID control such that the frequency component extracted by the Fourier coefficient computing unit 704 becomes zero. The PID control unit 709 performs PID control such that the frequency component extracted by the Fourier coefficient computing unit 705 becomes zero. Note that PID control, i.e., proportional integral differential control, is herein described as a typical control technique by way of example, but another type of control may also be used. The PID control units 708 and 709 are integral control units that perform control to bring to zero the SIN component and the COS component of the frequency component extracted by the Fourier coefficient computing units 704 and 705.

The AC restoration unit 710 receives computation results from the PID control units 708 and 709, and restores a single AC signal from the computation results. The AC restoration unit 710 outputs the restored AC signal as the d-axis current pulsation command i_{dAc}*. Thus, the d-axis current pulsation generation unit 603b can cause the d-axis current i_{d} to pulsate at the same frequency as the frequency of the q-axis current pulsation.

The pulsation signal is processed into the form of DC components within the d-axis current pulsation generation unit 603b, thereby making it possible to reduce the pulsation of a target frequency without unnecessarily increasing the control gain. When the integral control unit 602 alone attempts to perform flux-weakening control on a high-frequency component, the control gain needs increasing in which case an excessively high control gain may cause instability. For this reason, it is difficult for the integral control unit 602 alone to perform flux-weakening control on a high-frequency component. In contrast, adding the d-axis current pulsation generation unit 603b in parallel to the integral control unit 602 to separate flux-weakening control on a high-frequency component from flux-weakening control on a low frequency component can prevent instability of the control unit 400b, and thus provide good flux-weakening control.

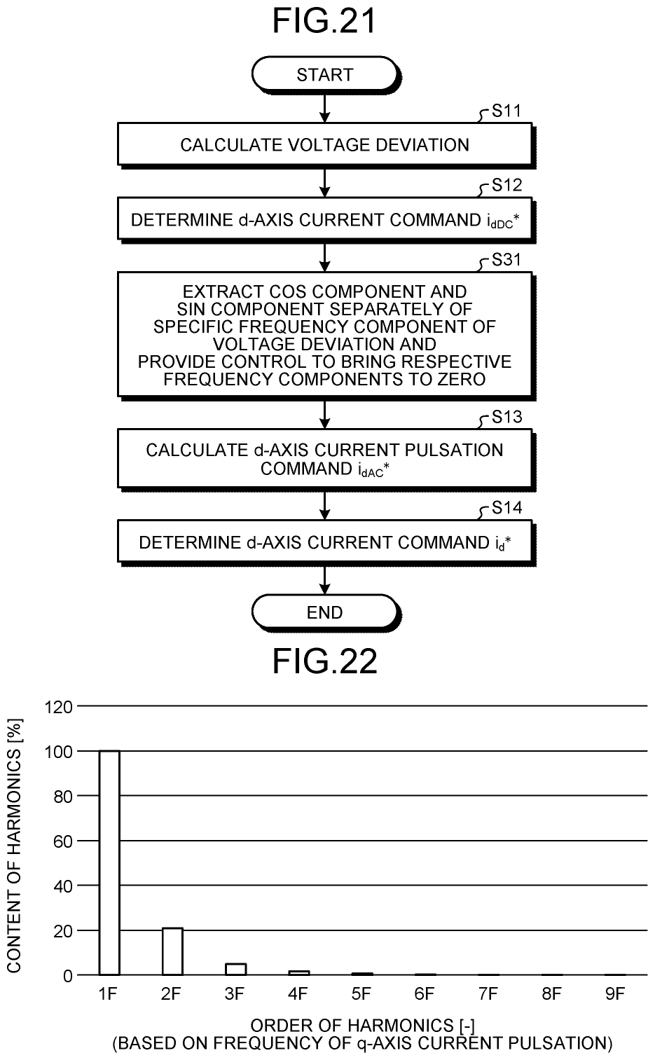

FIG. 21 is a flowchart illustrating an operation of the flux-weakening control unit 403b of the control unit 400b of the power converting apparatus 1 according to the third embodiment. In the flux-weakening control unit 403b, the subtraction unit 601 subtracts the dq-axis voltage command vector V_{dq}* from the voltage limit value Vₗᵢₘ* to calculate the voltage deviation (step S11). The integral control unit 602 performs integral control to bring the voltage deviation to zero and determines the d-axis current command i_{dDC}* (step S12). In the d-axis current pulsation generation unit 603b, the Fourier coefficient computing units 704 and 705 extract a COS component and a SIN component separately as DC components, of a specific frequency component of the voltage deviation through Fourier coefficient calculation. The PID control units 708 and 709 perform control to bring to zero the respective frequency components extracted by the Fourier coefficient computing units 704 and 705 (step S31). In the d-axis current pulsation generation unit 603b, the AC restoration unit 710 restores an AC signal from the computation results from the PID control units 708 and 709 to calculate the d-axis current pulsation command i_{dAc}* (step S13). The addition unit 604 adds together the d-axis current command i_{dDC}* and the d-axis current pulsation command i_{dAc}* to generate the d-axis current command i_{d}*, that is, to determine the d-axis current command i_{d}* (step S14).

A hardware configuration of the control unit 400b included in the power converting apparatus 1 will next be described. Similarly to the control unit 400 in the first embodiment, the control unit 400b is implemented by a combination of the processor 91 and the memory 92.

As described above, according to the present embodiment, the flux-weakening control unit 403b of the control unit 400b in the power converting apparatus 1 performs feedback-based flux-weakening control to determine the d-axis current command i_{d}*. Thus, the power converting apparatus 1 improves accuracy of flux-weakening control as compared to the first embodiment, and thus performs suitable flux-weakening control. This eliminates the need for the power converting apparatus 1 to carry an excess amount of the d-axis current i_{d}, thereby improving copper loss. The power converting apparatus 1 can reduce a decrease in efficiency in the overmodulation range as well as further reducing degradation of the smoothing capacitor 210 as compared to the first embodiment. In the present embodiment, the flux-weakening control unit 403b, which uses no motor constants, is characterized in being less susceptible to variation in a motor constant than the flux-weakening control unit 403 of the first embodiment and the flux-weakening control unit 403a of the second embodiment. In addition, since the phase of the d-axis current pulsation i_{dAC} is automatically adjusted by the PID control units 708 and 709, the flux-weakening control unit 403b is advantageous in more easily keeping the voltage amplitude constant even when current response cannot be increased so much. Note that the control technique of the third embodiment can also be combined with the control techniques of the first and second embodiments as appropriate.

### Fourth Embodiment

Although being very useful, the technique of the third embodiment controls the voltage deviation only in relation to the 1F component of the frequency of the q-axis current pulsation. For this reason, with a large amplitude of the q-axis current pulsation, the technique of the third embodiment fails to perform appropriate flux-weakening control, similarly to the first embodiment. In view of this, consider that the control of the third embodiment and the similar control on another frequency component of the voltage deviation are performed simultaneously in parallel. FIG. 22 is a diagram illustrating an example of frequency analysis result of an ideal d-axis current pulsation i_{dAc}. In FIG. 22, the horizontal axis represents the order of harmonics included in the voltage deviation, and the vertical axis represents the content of harmonics included in the voltage deviation. FIG. 22 illustrates a result of frequency analysis of the waveform of an ideal value illustrated in FIG. 12. Superimposition of only a pulsation of the 1F component on the d-axis current i_{d} fails to provide an ideal voltage locus, where the q-axis current pulsation frequency is the basic frequency, i.e., 1F. Addition of a pulsation of a 2F component as well will provide a voltage locus very close to the ideal voltage locus. Thus, the present embodiment will be described as to flux-weakening control for reducing the 1F component and the 2F component among the components of pulsation of the voltage deviation. Note that reduction of also 3F or higher components is ideal, and the control unit may therefore be configured to further include parallel control systems for 3F or higher components.

In a fourth embodiment, the control unit 400b is configured similarly to the control unit 400b of the third embodiment illustrated in FIG. 18. In addition, in the fourth embodiment, the flux-weakening control unit 403b is configured similarly to the flux-weakening control unit 403b of the third embodiment illustrated in FIG. 19. Note that although not illustrated, the power converting apparatus 1 according to the fourth embodiment includes the control unit 400b in place of the control unit 400 as compared to the power converting apparatus 1 of the first embodiment illustrated in FIG. 1.

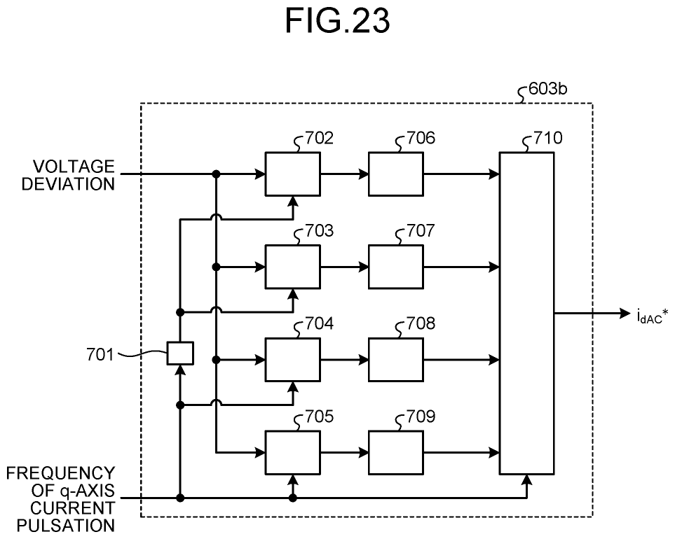

FIG. 23 is a block diagram illustrating an example configuration of the d-axis current pulsation generation unit 603b according to the fourth embodiment. The d-axis current pulsation generation unit 603b includes a gain unit 701, Fourier coefficient computing units 702 to 705, PID control units 706 to 709, and the AC restoration unit 710. In the fourth embodiment, the d-axis current pulsation generation unit 603b includes parallel control systems that each bring to zero only a specific frequency component for the voltage deviation. The fourth embodiment will be described taking an example of control systems that use Fourier coefficient calculation similarly to the third embodiment, but another type of control system that brings only a specific frequency component to zero may also be used.

The gain unit 701 multiplies the frequency of the q-axis current pulsation by N, where N is an integer greater than or equal to 2. The value of N is herein 2, but may be another value.

The Fourier coefficient computing units 702 to 705 extract a COS component and a SIN component separately as DC components, of specific frequency components of the voltage deviation through Fourier coefficient calculation. For example, one of the Fourier coefficient computing units 704 and 705 extracts a COS 1F component, and the other extracts a SIN 1F component, where the frequency of the q-axis current pulsation is the basic frequency, that is, the frequency of the q-axis current pulsation is 1f. In addition, one of the Fourier coefficient computing units 702 and 703 extracts a COS 2F component, and the other extracts a SIN 2F component. The control systems are described herein as reducing the voltage deviation pulsation at the frequency 1F and the frequency 2F by way of example, but a further control system for reducing another frequency component may be included in parallel to those control systems. As described above, the Fourier coefficient computing units 704 and 705 are first Fourier coefficient computing units that extract, from the voltage deviation, a SIN component and a COS component separately as DC components, of a specified first frequency component based on the q-axis current pulsation command i_{grip}*. The Fourier coefficient computing units 702 and 703 are second Fourier coefficient computing units that extract, from the voltage deviation, a SIN component and a COS component separately as DC components, of a second frequency component obtained by the gain unit 701.

The PID control unit 706 performs PID control such that the frequency component extracted by the Fourier coefficient computing unit 702 becomes zero. The PID control unit 707 performs PID control such that the frequency component extracted by the Fourier coefficient computing unit 703 becomes zero. The PID control unit 708 performs PID control such that the frequency component extracted by the Fourier coefficient computing unit 704 becomes zero. The PID control unit 709 performs PID control such that the frequency component extracted by the Fourier coefficient computing unit 705 becomes zero. Note that PID control, i.e., proportional integral differential control, is herein described as a typical control technique by way of example, but another type of control may also be used. The PID control units 708 and 709 are first integral control units that perform control to bring to zero the SIN component and the COS component of the first frequency component extracted by the Fourier coefficient computing units 704 and 705. The PID control units 706 and 707 are second integral control units that perform control to bring to zero the SIN component and the COS component of the second frequency component extracted by the Fourier coefficient computing units 702 and 703.

The AC restoration unit 710 receives computation results from the PID control units 706 to 709, and restores a single AC signal from the computation results. The AC restoration unit 710 outputs the restored AC signal as the d-axis current pulsation command i_{dAc}*. Thus, the d-axis current pulsation generation unit 603b can cause the d-axis current is to pulsate at a frequency including the 1F component and the 2F component of the q-axis current pulsation.

As described above, the control unit 400b superimposes the q-axis current pulsation command i_{grip}* on the drive pattern of the motor 314 in accordance with the detection value of a detection unit, the q-axis current pulsation command i_{grip}* corresponding to the q-axis current pulsation. The control unit 400b thus reduces the charge-discharge current I3 of the capacitor 210, and causes the d-axis current i_{d} of the motor 314 to pulsate in synchronization with the frequency of the q-axis current pulsation command i_{grip}* and a frequency that is a positive integer multiple of the frequency of the q-axis current pulsation command i_{grip}* during the saturation of the voltage of the inverter 310, the q-axis current pulsation command i_{grip}* corresponding to the q-axis current pulsation. In this respect, a positive integer is 2 in the present embodiment, but may be 3 or more, and may also be multiple numbers. For example, the positive integer is 1 and 2 in the present embodiment in other words. In other words, the foregoing description indicates that the control unit 400b superimposes the q-axis current pulsation command i_{grip}* on the drive pattern of the motor 314 in accordance with the detection value of a detection unit, the q-axis current pulsation command i_{grip}* corresponding to the q-axis current pulsation, and thus reduces the charge-discharge current I3 of the capacitor 210 and causes the d-axis current i_{d} to the motor 314 to pulsate in synchronization with frequencies that are each a positive integer multiple of the frequency of the q-axis current pulsation command i_{grip}* during the saturation of the voltage of the inverter 310.

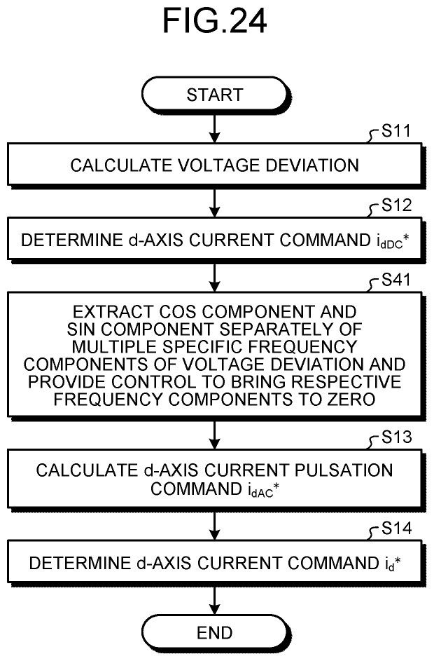

FIG. 24 is a flowchart illustrating an operation of the flux-weakening control unit 403b of the control unit 400b of the power converting apparatus 1 according to the fourth embodiment. In the flux-weakening control unit 403b, the subtraction unit 601 subtracts the dq-axis voltage command vector V_{dq}* from the voltage limit value Vₗᵢₘ* to calculate the voltage deviation (step S11). The integral control unit 602 performs integral control to bring the voltage deviation to zero and determines the d-axis current command i_{dDC}* (step S12). In the d-axis current pulsation generation unit 603b, the Fourier coefficient computing units 702 to 705 extract a COS component and a SIN component separately as DC components, of multiple specific frequency components of the voltage deviation through Fourier coefficient calculation. The PID control units 706 to 709 perform control to bring to zero the respective frequency components extracted by the Fourier coefficient computing units 702 to 705 (step S41). In the d-axis current pulsation generation unit 603b, the AC restoration unit 710 restores an AC signal from the computation results from the PID control units 706 to 709 to calculate the d-axis current pulsation command i_{dAC}* (step S13). The addition unit 604 adds together the d-axis current command i_{dDC}* and the d-axis current pulsation command i_{dAc}* to generate the d-axis current command i_{d}*, that is, to determine the d-axis current command i_{d}* (step S14).

As described above, according to the present embodiment, the flux-weakening control unit 403b of the control unit 400b in the power converting apparatus 1 performs feedback-based flux-weakening control using multiple specific frequency components to determine the d-axis current command i_{d}*. Thus, the power converting apparatus 1 improves accuracy of flux-weakening control as compared to the third embodiment, and thus performs suitable flux-weakening control. This eliminates the need for the power converting apparatus 1 to carry an excess amount of the d-axis current i_{d}, thereby improving copper loss. The power converting apparatus 1 can reduce a decrease in efficiency in the overmodulation range as well as further reducing degradation of the smoothing capacitor 210 as compared to the third embodiment.

### Fifth Embodiment

The power converting apparatus 1 according to the first through fourth embodiments aims at improving the waveform of the d-axis current i_{d}, while the power converting apparatus 1 according to a fifth embodiment prevents increase in copper loss by improving the waveform of the q-axis current i_{q}. As illustrated in FIG. 1, the power converting apparatus 1 includes components such as the reactor 120 and the rectifier unit 130, and the smoothing unit 200 uses, for example, the capacitor 210, i.e., a smoothing capacitor. When components such as the reactor 120 and the capacitor 210 in the power converting apparatus 1 have a large capacity, the current flowing into the capacitor 210 has a form resembling a “rabbit ear” as described above. In such case, in order to reduce the capacitor current pulsation, it is important to address not only the fundamental wave frequency of the capacitor current pulsation but also a frequency twice the fundamental frequency. The control system was configured to provide the q-axis current i_{q} with a pulsation of the fundamental wave frequency of the capacitor current pulsation and a frequency twice the fundamental wave frequency and also provide the d-axis current i_{d} with a pulsation in synchronization with the q-axis current pulsation. As a result, it was turned out that the addition of a pulsation having a frequency twice the fundamental frequency at the same time provided a smaller copper loss in a heavy load range than when a pulsation is provided only at the fundamental wave frequency. In contrast, under a light load condition with a light load on the motor 314, it turned out that the addition of a pulsation having a frequency twice the foregoing frequency at the same time worsened the copper loss. The copper loss is improved by the addition of a pulsation having a frequency twice the foregoing frequency at the same time under a heavy load condition with a heavy load on the motor 314. Such a phenomenon is non-obvious.

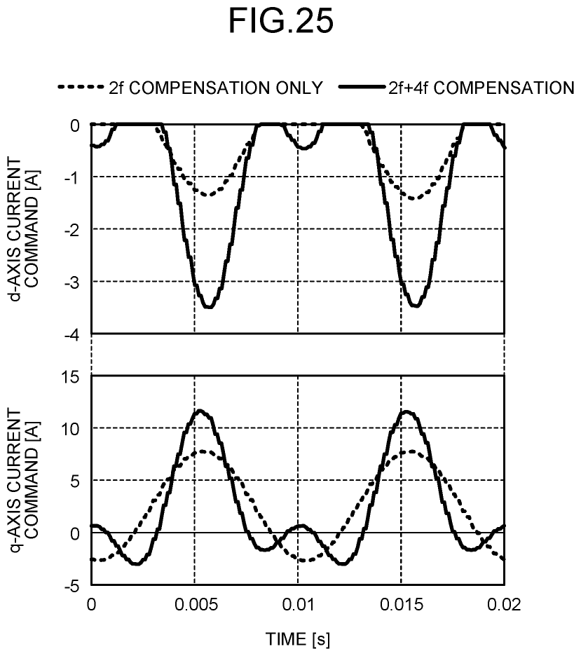

This phenomenon will next be described with reference to a waveform. FIG. 25 is a diagram illustrating an example of waveforms of current commands in a light load range. In FIG. 25, the horizontal axes represent time, the vertical axis of the upper graph represents the d-axis current command, and the vertical axis of the lower graph represents the q-axis current command. In this example, the frequency of a single-phase AC power supply is the fundamental wave frequency, i.e., 1f, and thus the fundamental wave frequency of the capacitor current pulsation is 2f. The frequency twice the fundamental wave frequency 2f of the capacitor current pulsation is 4f. Note that the fundamental wave frequency 2f is the same frequency as the foregoing power supply frequency 2f. One possible way to reduce the capacitor current pulsation is to provide a sinusoidal q-axis current i_{q}. However, when components such as the reactor 120 and the capacitor 210 have a large capacity, it is preferable to provide a 4f pulsation at the same time as the 2f pulsation to form the q-axis current i_{q} in a steeper waveform as a “rabbit ear” shape, if a further reduction of the capacitor current is the only purpose. The q-axis current i_{q} will have a greater peak value when having a 4f pulsation superimposed thereon, which may lead to voltage saturation. In view of this, a pulsation is provided to the d-axis current is, too. Note that the upper limit value of the d-axis current i_{d} is clamped at zero in this example because carrying the d-axis current is in the positive direction is not advantageous. Because copper loss in the motor 314 is proportional to the square sum of the dq-axis currents, providing a 4f pulsation at the same time will lead to a greater copper loss in a light load condition. This is obvious from FIG. 25.

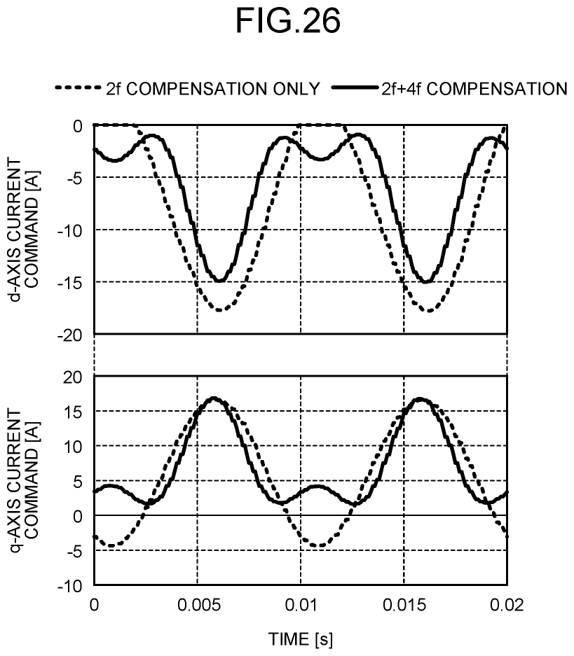

FIG. 26 is a diagram illustrating an example of waveforms of the current commands in a heavy load range. In FIG. 26, the horizontal axes represent time, the vertical axis of the upper graph represents the d-axis current command, and the vertical axis of the lower graph represents the q-axis current command. It is known that the dq-axis currents allowed to flow to the motor 314 have upper limits because of a demagnetization limit of the motor 314, voltage saturation, and the like. When the q-axis current i_{q} is set to have almost the same maximum values, the addition of a 2f pulsation and a 4f pulsation at the same time reduces the pulsation amplitude of the q-axis current i_{q}. This is because the downward variation in the q-axis current i_{q} is more reduced by the addition of the 4f pulsation and the 2f pulsation at the same time than when only the 2f pulsation is provided. Because a change in the q-axis current i_{q} to below the average value reduces the motor speed, an acceleration torque is needed in order to compensate this speed reduction. To generate an acceleration torque in a voltage saturation range, a larger amount of the d-axis current i_{d} needs to flow to mitigate the situation of voltage saturation, but the copper loss will increase because of the flow of the d-axis current i_{d}. In a heavy load condition with the saturation of the q-axis current i_{q}, it is possible to reduce the speed reduction of the motor 314 by reducing the downward variation in the q-axis current i_{q}. As a result, the d-axis current i_{d} is reduced, thereby reducing the copper loss. This is a phenomenon newly discovered by the present inventors, and is non-obvious also to other persons skilled in the art. The capacitor current (not illustrated) had the same degree, but compensation of the 4f pulsation at the same time reduced the copper loss by about 40%.

The fifth embodiment is based on a knowledge that “when capacitor current pulsation components having a frequency twice and a frequency four times the frequency of the AC power supply are corrected at the same time in performing control that reduces the capacitor current pulsation, the flux-weakening current decreases in a heavy load condition”. The following description is based on this knowledge.

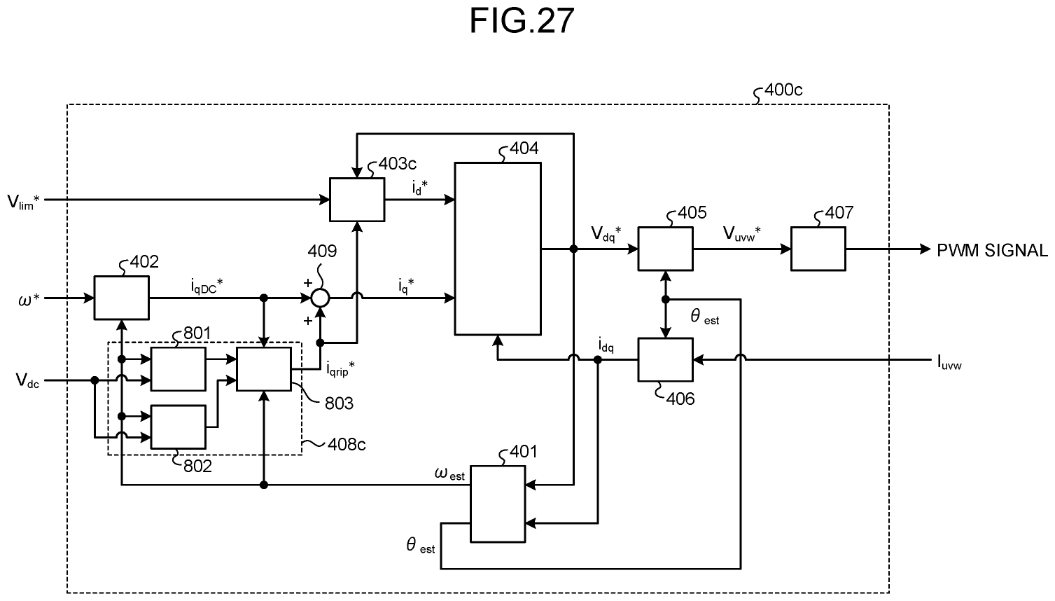

FIG. 27 is a block diagram illustrating an example configuration of a control unit 400c of the power converting apparatus 1 according to the fifth embodiment. The control unit 400c includes a flux-weakening control unit 403c in place of the flux-weakening control unit 403, and includes a q-axis current pulsation computing unit 408c in place of the q-axis current pulsation computing unit 408 as compared to the control unit 400 of the first embodiment illustrated in FIG. 2. The q-axis current pulsation computing unit 408c includes a first q-axis current pulsation computing unit 801, a second q-axis current pulsation computing unit 802, and an operating condition determination unit 803. Note that although not illustrated, the power converting apparatus 1 according to the fifth embodiment includes the control unit 400c in place of the control unit 400 as compared to the power converting apparatus 1 of the first embodiment illustrated in FIG. 1. A description will be made below taking an example in which the commercial power supply 110 is a single-phase AC power supply. Assume that the supply voltage Vₛ supplied from the commercial power supply 110 has a frequency of 1f. Since the commercial power supply 110 is a single-phase AC power supply, the fundamental frequency of the capacitor current pulsation is 2f, and the frequency twice the fundamental frequency of the capacitor current pulsation is 4f.

The first q-axis current pulsation computing unit 801 is a control system for reducing the 2f pulsation of the DC bus voltage V_{dc}, and computes and outputs a first q-axis current pulsation command for compensating the 2f pulsation of the DC bus voltage V_{dc}, where 2f is the fundamental frequency of the capacitor current pulsation. The second q-axis current pulsation computing unit 802 is a control system for reducing the 4f pulsation of the DC bus voltage V_{dc}, and computes and outputs a second q-axis current pulsation command for compensating the 4f pulsation of the DC bus voltage V_{dc}. It is known that these control systems can reduce the current flowing to the capacitor 210 of the smoothing unit 200.

The operating condition determination unit 803 determines the operating condition of the motor 314, that is, the magnitude of the load applied to the motor 314. When the operating condition determination unit 803 determines that the load applied to the motor 314 is a light load, the operating condition determination unit 803 selects the output from the first q-axis current pulsation computing unit 801, and outputs the selected output as the q-axis current pulsation command i_{q}*. Alternatively, when the operating condition determination unit 803 determines that the load applied to the motor 314 is a heavy load, the operating condition determination unit 803 adds together the output from the first q-axis current pulsation computing unit 801 and the output from the second q-axis current pulsation computing unit 802, and outputs the sum as the q-axis current pulsation command i_{grip}*.

The operating condition determination unit 803 may determine the operating condition in various methods. One possible method is, for example, to use the q-axis current command i_{qDC}*, which is the output from the speed control unit 402, and the estimated speed ωₑₛₜ, which is an output from the rotor position estimation unit 401. Multiplication of the q-axis current command i_{qDC}* by the estimated speed ωₑₛₜ yields average output power Pc of the motor 314. On the basis of the magnitude of the average output power P_{DC} of the motor 314, thus, the operating condition determination unit 803 can determine whether the load applied to the motor 314 is a heavy load or a light load. It is more preferred that thresholds for determination of whether the load is the heavy load or the light load have a hysteresis tolerance set to prevent chattering between the determinations of the heavy load and the light load when the operating condition determination unit 803 makes the determination. For example, the operating condition determination unit 803 can perform a process of determining that the load becomes a heavy load when the average output power P_{DC} has exceeded 60% of maximum output power, and then determining that the load becomes a light load when the average output power P_{DC} has fallen below 40% of the maximum output power. Note that the exemplified thresholds of 60%, 40%, etc. are discussed by way of example, and another value may be used.

In addition, another possible method for determination is to use the voltage applied to the motor 314 and the current flowing to the motor 314. Multiplication of the voltage by the current yields the input power to the motor 314. The operating condition determination unit 803 may thus calculate the input power to the motor 314 and determine whether the load applied to the motor 314 is a heavy load or a light load.

Moreover, still another possible method for determination is, for example, to use a sum of the q-axis current command i_{qDC}* and the output from the first q-axis current pulsation computing unit 801. The operating condition determination unit 803 determines that the load is a light load when the sum has not reached a limit value of the q-axis current i_{q} (not illustrated), and determines that the load is a heavy load when the sum has reached the limit value of the q-axis current i_{q}.

There are various methods for the operating condition determination unit 803 to determine whether the load applied to the motor 314 is a heavy load or a light load in addition to the foregoing exemplified methods, and any of such methods may be used. Note that for the purpose of simplifying the configuration of the control system of the control unit 400c, the operating condition determination unit 803 may be omitted to always compensate the 2f pulsation and the 4f pulsation simultaneously.

The flux-weakening control unit 403c is a control system that generates the d-axis current pulsation i_{dAC} in synchronization with the q-axis current pulsation, and provides the d-axis current command i_{d}* including the 1f pulsation and the 2f pulsation. The flux-weakening control unit 403c may be configured similarly to the first embodiment and the third embodiment, or may be configured to also provide a pulsation having another frequency to the d-axis current i_{d} at the same time similarly to the second embodiment and the fourth embodiment.

Although a problem of trade-off exists between copper loss and capacitor current in a heavy load range, use of the configuration as described in the present embodiment enables the control unit 400c to suitably reduce the capacitor current while reducing increase in copper loss.

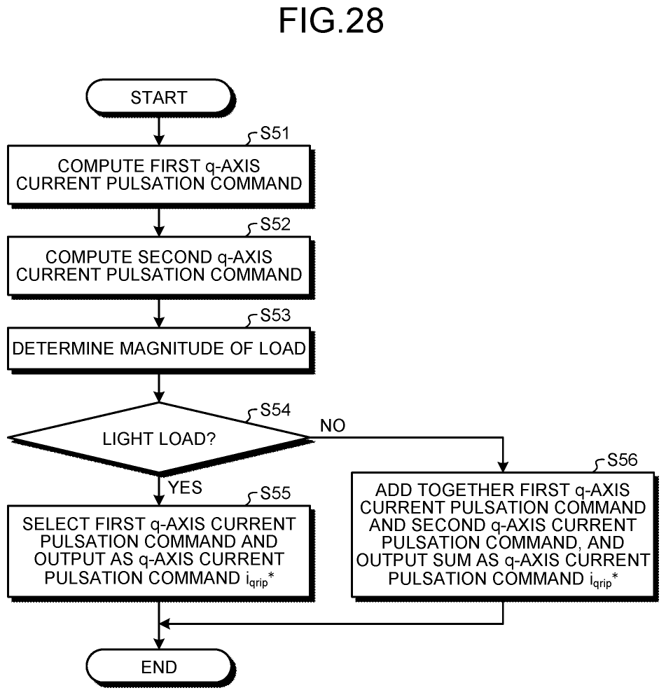

FIG. 28 is a flowchart illustrating an operation of the q-axis current pulsation computing unit 408c of the control unit 400c of the power converting apparatus 1 according to the fifth embodiment. In the q-axis current pulsation computing unit 408c, the first q-axis current pulsation computing unit 801 computes a first q-axis current pulsation command for compensating the 2f pulsation of the DC bus voltage V_{dc} (step S51). The second q-axis current pulsation computing unit 802 computes a second q-axis current pulsation command for compensating the 4f pulsation of the DC bus voltage V_{dc} (step S52). The operating condition determination unit 803 determines the magnitude of the load applied to the motor 314 (step S53). When the load is a light load (step S54: Yes), the operating condition determination unit 803 selects the first q-axis current pulsation command, and outputs the first q-axis current pulsation command as the q-axis current pulsation command i_{grip}* (step S55). When the load is a heavy load (step S54: No), the operating condition determination unit 803 adds together the first q-axis current pulsation command and the second q-axis current pulsation command, and outputs the sum as the q-axis current pulsation command i_{grip}* (step S56).

As described above, when the commercial power supply 110 is a single-phase AC power supply, the q-axis current pulsation computing unit 408c determines the load on the motor 314. When the q-axis current pulsation computing unit 408c determines that the load is the light load through a comparison with a threshold for determining that the load is the light load that is a defined load, the q-axis current pulsation computing unit 408c generates the q-axis current pulsation command i_{grip}* for compensating the pulsation having a frequency twice the frequency of the first AC power. When the q-axis current pulsation computing unit 408c determines that the load is the heavy load through a comparison with a threshold for determining that the load is the heavy load that is a defined load, the q-axis current pulsation computing unit 408c generates the q-axis current pulsation command i_{grip}* for compensating the pulsation having a frequency twice the frequency of the first AC power and the pulsation having a frequency four times the frequency of the first AC power.

Note that although the commercial power supply 110 has been described as being a single-phase AC power supply, the present embodiment is also applicable where the commercial power supply 110 is a three-phase AC power supply. When the commercial power supply 110 is a three-phase AC power supply, the capacitor current pulsation has a fundamental frequency that is three times larger than when the commercial power supply 110 is a single-phase AC power supply. That is, when the commercial power supply 110 is a three-phase AC power supply, the capacitor current pulsation has a fundamental frequency of 6f, and the frequency twice the fundamental frequency of the capacitor current pulsation is 12f.

When the commercial power supply 110 is a three-phase AC power supply, the q-axis current pulsation computing unit 408c determines the load on the motor 314. When the q-axis current pulsation computing unit 408c determines that the load is the light load through a comparison with a threshold for determining that the load is the light load that is a defined load, the q-axis current pulsation computing unit 408c generates the q-axis current pulsation command i_{grip}* for compensating a pulsation having a frequency six times the frequency of the first AC power. When the q-axis current pulsation computing unit 408c determines that the load is the heavy load through a comparison with a threshold for determining that the load is the heavy load that is a defined load, the q-axis current pulsation computing unit 408c generates the q-axis current pulsation command i_{grip}* for compensating the pulsation having a frequency six times the frequency of the first AC power and a pulsation having a frequency twelve times the frequency of the first AC power.

A hardware configuration of the control unit 400c included in the power converting apparatus 1 will next be described. Similarly to the control unit 400 in the first embodiment, the control unit 400c is implemented by a combination of the processor 91 and the memory 92.

As described above, according to the present embodiment, the q-axis current pulsation computing unit 408c of the control unit 400c in the power converting apparatus 1 outputs, as the q-axis current pulsation command i_{grip}*, the sum of a first q-axis current pulsation command for compensating the 1f pulsation of the DC bus voltage V_{dc} and a second q-axis current pulsation command for compensating the 2f pulsation of the DC bus voltage V_{dc} when the load applied to the motor 314 is high. This enables the power converting apparatus 1 to suitably reduce the capacitor current as well as to reduce increase in copper loss as compared to the first embodiment. Note that the control technique of the fifth embodiment can also be combined with the control techniques of the first through fourth embodiments as appropriate.

### Sixth Embodiment

In the first through fifth embodiments, the power converting apparatus 1 has been described as performing capacitor current reducing control and flux-weakening control. Among these types of control, the flux-weakening control of the second through fourth embodiments is also applicable to the technology of Patent Literature 1. The flux-weakening control described in Patent Literature 1 uses a technique similar to the technique of the flux-weakening control according to the first embodiment, but causes a large error between a value on an approximate tangent and an ideal value as described above, thereby making it unlikely to perform reasonable flux-weakening control. A power converting apparatus of a sixth embodiment uses the flux-weakening control of the second through fourth embodiments, and can thus improve accuracy of flux-weakening control in performing vibration reducing control and flux-weakening control.

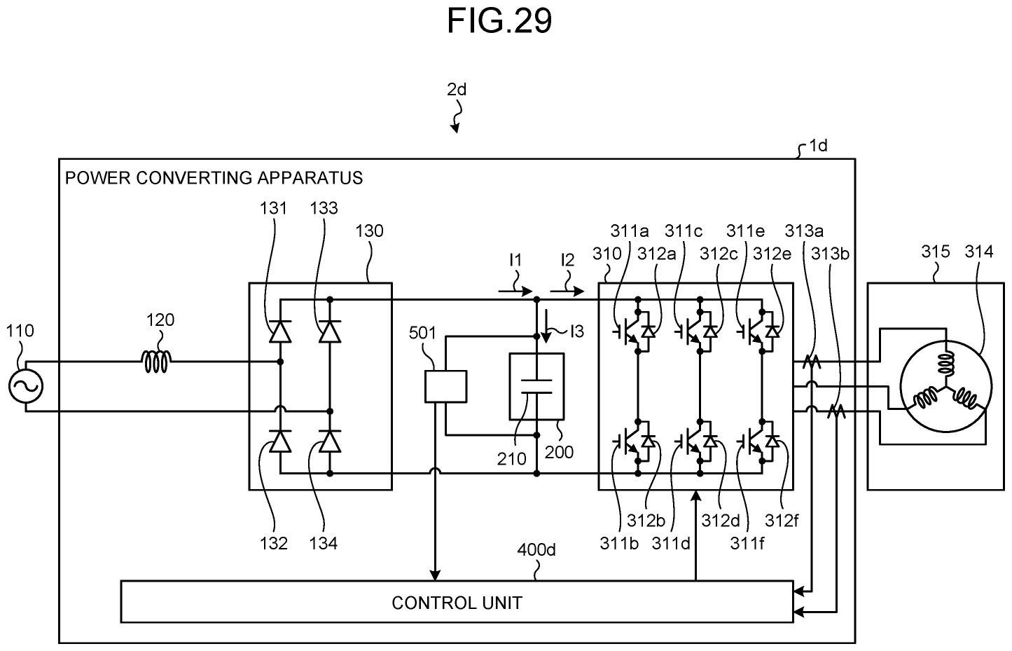

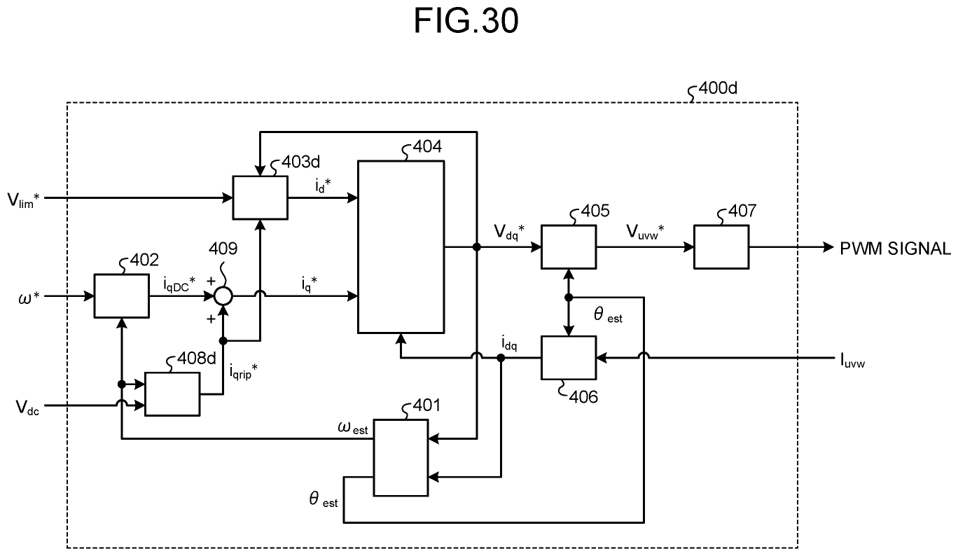

FIG. 29 is a diagram illustrating an example configuration of a power converting apparatus 1d according to the sixth embodiment. The power converting apparatus 1d includes a control unit 400d in place of the control unit 400 of the power converting apparatus 1 illustrated in FIG. 1. Note that the power converting apparatus 1d and the motor 314 of the compressor 315 define a motor drive unit 2d. FIG. 30 is a block diagram illustrating an example configuration of the control unit 400d of the power converting apparatus 1d according to the sixth embodiment. The control unit 400d includes a flux-weakening control unit 403d in place of the flux-weakening control unit 403a, and includes a q-axis current pulsation computing unit 408d in place of the q-axis current pulsation computing unit 408, as compared to the control unit 400a of the second embodiment illustrated in FIG. 13.

The q-axis current pulsation computing unit 408d, which corresponds to a speed pulsation reducing control unit or a vibration reducing control unit described in paragraph 0025 of Patent Literature 1, outputs the q-axis current pulsation command i_{grip}* corresponding to a q-axis current pulsation i Ac of Patent Literature 1. The specific configuration of the q-axis current pulsation computing unit 408d corresponding to the speed pulsation reducing control unit or to the vibration reducing control unit can be a general configuration, and no specific configuration is required similarly to Patent Literature 1.

The flux-weakening control unit 403d performs flux-weakening control, taking into account the q-axis current pulsation command i_{grip}* computed by the q-axis current pulsation computing unit 408d. The q-axis current pulsation command i_{grip}* of the sixth embodiment differs in pulsation frequency from the q-axis current pulsation command i_{grip}* of the second through fourth embodiments. Nevertheless, the flux-weakening control unit 403d, which is configured similarly to the flux-weakening control unit 403a of the second embodiment or to the flux-weakening control unit 403b of the third and fourth embodiments, is capable of automatically adjusting the d-axis current command i_{d}* corresponding to the vibration reducing control.

As described above, the control unit 400d superimposes the q-axis current pulsation, which is a pulsatile component of the q-axis current i_{q}, on the drive pattern of the motor 314 in accordance with the detection value of a detection unit. The control unit 400d thus reduces vibration caused by rotation of the motor 314, and causes the d-axis current is to the motor 314 to pulsate in synchronization with a frequency that is a positive integer multiple of the frequency of the q-axis current pulsation during the saturation of the voltage of the inverter. Note that, as described above, a single positive integer or multiple positive integers may be used. For example, the positive integer may be 1 alone or may be 1 and 2.

Where the control unit 400d operates similarly to the control unit 400a of the second embodiment, the control unit 400d is configured similarly to the control unit 400a illustrated in FIG. 13 and includes the flux-weakening control unit 403a illustrated in FIG. 15, as the flux-weakening control unit 403d. The components of the control unit 400a and of the flux-weakening control unit 403a operate as described above.

Alternatively, where the control unit 400d operates similarly to the control unit 400b of the third embodiment, the control unit 400d is configured similarly to the control unit 400b illustrated in FIG. 18 and includes the flux-weakening control unit 403b illustrated in FIG. 19, as the flux-weakening control unit 403d. In addition, the flux-weakening control unit 403b includes the d-axis current pulsation generation unit 603b illustrated in FIG. 20. The components of the control unit 400b, of the flux-weakening control unit 403b, and of the d-axis current pulsation generation unit 603b operate as described above.

Still alternatively, where the control unit 400d operates similarly to the control unit 400b of the fourth embodiment, the control unit 400d is configured similarly to the control unit 400b illustrated in FIG. 18 and includes the flux-weakening control unit 403b illustrated in FIG. 19, as the flux-weakening control unit 403d. In addition, the flux-weakening control unit 403b includes the d-axis current pulsation generation unit 603b illustrated in FIG. 23. The components of the control unit 400b, of the flux-weakening control unit 403b, and of the d-axis current pulsation generation unit 603b operate as described above.

A hardware configuration of the control unit 400d included in the power converting apparatus 1d will next be described. Similarly to the control unit 400 in the first embodiment, the control unit 400d is implemented by a combination of the processor 91 and the memory 92.

As described above, according to the present embodiment, the flux-weakening control unit 403d of the control unit 400d in the power converting apparatus 1d performs control similar to the flux-weakening control of the second through fourth embodiments. This enables the power converting apparatus 1d to improve accuracy of flux-weakening control to thereby perform suitable flux-weakening control. This eliminates the need for the power converting apparatus 1d to carry an excess amount of the d-axis current i_{d}, thereby improving copper loss. The power converting apparatus 1d can reduce a decrease in efficiency in the overmodulation range as well as reducing vibration caused by rotation of the motor 314.

### Seventh Embodiment

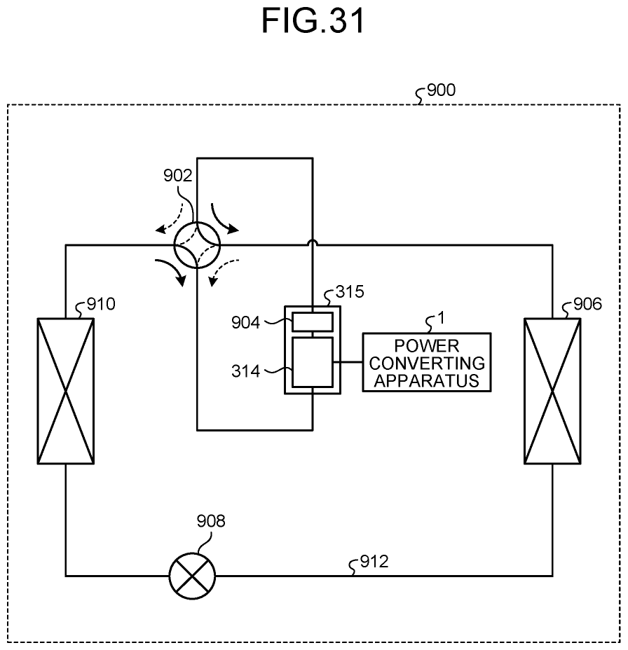

FIG. 31 is a diagram illustrating an example configuration of a refrigeration cycle-incorporating apparatus 900 according to a seventh embodiment. The refrigeration cycle-incorporating apparatus 900 according to the seventh embodiment includes the power converting apparatus 1 described in the first through fifth embodiments. Although the refrigeration cycle-incorporating apparatus 900 can include the power converting apparatus 1d described in the sixth embodiment, description will be given below in the context of a case of including the power converting apparatus 1 by way of example. The refrigeration cycle-incorporating apparatus 900 according to the seventh embodiment can be employed as a product including a refrigeration cycle, such as an air conditioner, a refrigerator, a freezer, or a heat pump water heater. Note that, in FIG. 31, components that function similarly to those in the first embodiment are designated by the same reference characters as used in the first embodiment.

The refrigeration cycle-incorporating apparatus 900 includes the compressor 315 incorporating the motor 314 according to the first embodiment, a four-way valve 902, an indoor heat exchanger 906, an expansion valve 908, and an outdoor heat exchanger 910, which are connected to each other via a refrigerant pipe 912.

The compressor 315 includes therein a compression mechanism 904 for compressing a refrigerant, and the motor 314 for driving the compression mechanism 904.

The refrigeration cycle-incorporating apparatus 900 is capable of operating in either a heating mode or a cooling mode through switching operation of the four-way valve 902. The compression mechanism 904 is driven by the motor 314, which is controlled to operate at a variable speed.

In the heating mode, the refrigerant is pressurized and discharged by the compression mechanism 904, flows through the four-way valve 902, the indoor heat exchanger 906, the expansion valve 908, the outdoor heat exchanger 910, and the four-way valve 902, and returns back to the compression mechanism 904 as indicated by the solid line arrows.

In the cooling mode, the refrigerant is pressurized and discharged by the compression mechanism 904, flows through the four-way valve 902, the outdoor heat exchanger 910, the expansion valve 908, the indoor heat exchanger 906, and the four-way valve 902, and returns back to the compression mechanism 904 as indicated by the broken line arrows.

In the heating mode, the indoor heat exchanger 906 acts as a condenser to release heat, while the outdoor heat exchanger 910 acts as an evaporator to absorb heat.

In the cooling mode, the outdoor heat exchanger 910 acts as a condenser to release heat, while the indoor heat exchanger 906 acts as an evaporator to absorb heat. The expansion valve 908 depressurizes and expands the refrigerant.

The configurations described in the foregoing embodiments are merely examples. These configurations may be combined with a known other technology, and configurations of different embodiments may be combined together. Moreover, part of such configurations may be omitted and/or modified without departing from the spirit thereof.

### REFERENCE SIGNS LIST

1, 1d power converting apparatus; 2, 2d motor drive unit; 110 commercial power supply; 120 reactor; 130 rectifier unit; 131 to 134 rectifier element; 200 smoothing unit; 210 capacitor; 310 inverter; 311a to 311f switching element; 312a to 312f freewheeling diode; 313a, 313b current detection unit; 314 motor; 315 compressor; 400, 400a, 400b, 400c, 400d control unit; 401 rotor position estimation unit; 402 speed control unit; 403, 403a, 403b, 403c, 403d flux-weakening control unit; 404 current control unit; 405, 406 coordinate conversion unit; 407 PWM signal generation unit; 408, 408c, 408d q-axis current pulsation computing unit; 409 addition unit; 501 voltage detection unit; 601 subtraction unit; 602 integral control unit; 603, 603b d-axis current pulsation generation unit; 604 addition unit; 605 d-axis current pulsation readjustment unit; 701 gain unit; 702 to 705 Fourier coefficient computing unit; 706 to 709 PID control unit; 710 AC restoration unit; 801 first q-axis current pulsation computing unit; 802 second q-axis current pulsation computing unit; 803 operating condition determination unit; 900 refrigeration cycle-incorporating apparatus; 902 four-way valve; 904 compression mechanism; 906 indoor heat exchanger; 908 expansion valve; 910 outdoor heat exchanger; 912 refrigerant pipe.

1. A power converting apparatus comprising:
a rectifier unit rectifying first alternating-current power supplied from a commercial power supply;
a capacitor connected to an output end of the rectifier unit;
an inverter connected across the capacitor, the inverter generating second alternating-current power and outputting the second alternating-current power to a motor;
a detection unit detecting a power state of the capacitor; and
a control unit controlling an operation of the inverter and an operation of the motor, using a dq-rotational coordinate system, the dq-rotational coordinate system rotating in synchronization with a rotor position of the motor, wherein
the control unit superimposes a q-axis current pulsation on a drive pattern of the motor in accordance with a detection value of the detection unit to reduce a charge-discharge current of the capacitor, and to cause a d-axis current to the motor to pulsate in synchronization with a frequency that is a positive integer multiple of a frequency of the q-axis current pulsation during saturation of a voltage of the inverter, the q-axis current pulsation being a pulsatile component of a q-axis current.

2. The power converting apparatus according to claim 1, wherein
the control unit includes
a speed control unit generating a first q-axis current command from a speed command and an estimated speed,
a q-axis current pulsation computing unit computing the q-axis current pulsation, using the detection value to generate a q-axis current pulsation command,
an addition unit generating a second q-axis current command by adding together the first q-axis current command and the q-axis current pulsation command,
a flux-weakening control unit generating a d-axis current pulsation command for causing the d-axis current to pulsate in synchronization with the q-axis current pulsation command, the flux-weakening control unit generating a first d-axis current command from a voltage deviation between a dq-axis voltage command and a voltage limit value, the first d-axis current command having a frequency lower than a frequency of the d-axis current pulsation command, the flux-weakening control unit adding together the first d-axis current command and the d-axis current pulsation command to generate a second d-axis current command, and
a current control unit controlling a current flowing to the motor, using the second q-axis current command and the second d-axis current command, and generating the dq-axis voltage command.

3. The power converting apparatus according to claim 2, wherein
the flux-weakening control unit generates the d-axis current pulsation command on a basis of a result of multiplication of a tangent of an average value of an angular advance of voltage by the q-axis current pulsation command.

4. The power converting apparatus according to claim 2, wherein
the flux-weakening control unit generates the d-axis current pulsation command in such a manner as to keep a locus of a vector of the dq-axis voltage command extending in a circumferential direction or a tangential direction of a voltage limit circle having a specified radius, the specified radius being based on the voltage limit value.

5. The power converting apparatus according to claim 2, wherein
the flux-weakening control unit includes
a d-axis current pulsation generation unit generating the d-axis current pulsation command for reducing increase and decrease in an amplitude of the dq-axis voltage command, the increase and decrease being caused by the q-axis current pulsation, the d-axis current pulsation command being synchronized with the q-axis current pulsation, and
a d-axis current pulsation readjustment unit examining an amount of increase and decrease in the amplitude of the dq-axis voltage command, and readjusting the d-axis current pulsation command in accordance with the amount of the increase and decrease, the increase and decrease being caused by the q-axis current pulsation command and the d-axis current pulsation command, and
the flux-weakening control unit adds together the first d-axis current command and the readjusted d-axis current pulsation command to generate the second d-axis current command.

6. The power converting apparatus according to claim 2, wherein
the flux-weakening control unit includes
a d-axis current pulsation generation unit generating, depending on the voltage deviation, the d-axis current pulsation command for reducing increase and decrease in an amplitude of the dq-axis voltage command, and
the d-axis current pulsation generation unit includes
Fourier coefficient computing units that extract, from the voltage deviation, a sine component and a cosine component separately as direct-current components, of a specified frequency component based on the q-axis current pulsation command,
integral control units that provide control to bring to zero the sine component and the cosine component of the frequency component extracted by the Fourier coefficient computing units, and
an alternating-current restoration unit restoring a single alternating-current signal from computation results from the integral control units, and outputs the single alternating-current signal as the d-axis current pulsation command.

7. The power converting apparatus according to claim 2, wherein
the flux-weakening control unit includes
a d-axis current pulsation generation unit generating, depending on the voltage deviation, the d-axis current pulsation command for reducing increase and decrease in an amplitude of the dq-axis voltage command, and
the d-axis current pulsation generation unit includes
first Fourier coefficient computing units that extract, from the voltage deviation, a sine component and a cosine component separately as direct-current components, of a specified first frequency component based on the q-axis current pulsation command,
first integral control units that provide control to bring to zero the sine component and the cosine component of the first frequency component extracted by the first Fourier coefficient computing units,
a gain unit multiplying a frequency of the q-axis current pulsation command by N, N being a positive integer greater than or equal to 2,
second Fourier coefficient computing units that extract, from the voltage deviation, a sine component and a cosine component separately as direct-current components, of a second frequency component obtained by the gain unit,
second integral control units that provide control to bring to zero the sine component and the cosine component of the second frequency component extracted by the second Fourier coefficient computing units, and
an alternating-current restoration unit restoring a single alternating-current signal from computation results from the first integral control units and from computation results from the second integral control units, and outputs the single alternating-current signal as the d-axis current pulsation command.

8. The power converting apparatus according to claim 2, wherein
the commercial power supply is a single-phase alternating-current power supply,
the q-axis current pulsation computing unit determines a load on the motor,
when the q-axis current pulsation computing unit determines, through a comparison with a threshold for determining that the load is a light load, that the load is the light load, the q-axis current pulsation computing unit generates the q-axis current pulsation command for compensating a pulsation having a frequency twice a frequency of the first alternating-current power, the light load being a defined load, and
when the q-axis current pulsation computing unit determines, through a comparison with a threshold for determining that the load is a heavy load, that the load is the heavy load, the q-axis current pulsation computing unit generates the q-axis current pulsation command for compensating the pulsation having the frequency twice the frequency of the first alternating-current power and a pulsation having a frequency four times the frequency of the first alternating-current power, the heavy load being a defined load.

9. The power converting apparatus according to claim 2, wherein
the commercial power supply is a three-phase alternating-current power supply,
the q-axis current pulsation computing unit determines a load on the motor,
when the q-axis current pulsation computing unit determines, through a comparison with a threshold for determining that the load is a light load, that the load is the light load, the q-axis current pulsation computing unit generates the q-axis current pulsation command for compensating a pulsation having a frequency six times a frequency of the first alternating-current power, the light load being a defined load, and
when the q-axis current pulsation computing unit determines, through a comparison with a threshold for determining that the load is a heavy load, that the load is the heavy load, the q-axis current pulsation computing unit generates the q-axis current pulsation command for compensating the pulsation having the frequency six times the frequency of the first alternating-current power and a pulsation having a frequency twelve times the frequency of the first alternating-current power, the heavy load being a defined load.

10. A power converting apparatus comprising:
a rectifier unit rectifying first alternating-current power supplied from a commercial power supply;
a capacitor connected to an output end of the rectifier unit;
an inverter connected across the capacitor, the inverter generating second alternating-current power and outputting the second alternating-current power to a motor;
a detection unit detecting a power state of the capacitor; and
a control unit controlling an operation of the inverter and an operation of the motor using a dq-rotational coordinate system, the dq-rotational coordinate system rotating in synchronization with a rotor position of the motor, wherein
the control unit superimposes a q-axis current pulsation on a drive pattern of the motor in accordance with a detection value of the detection unit to reduce vibration caused by rotation of the motor, and to cause a d-axis current to the motor to pulsate in synchronization with a frequency that is a positive integer multiple of a frequency of the q-axis current pulsation during saturation of a voltage of the inverter saturates, the q-axis current pulsation being a pulsatile component of a q-axis current.

11. The power converting apparatus according to claim 10, wherein
the control unit includes
a speed control unit generating a first q-axis current command from a speed command and on an estimated speed,
a q-axis current pulsation computing unit computing the q-axis current pulsation, using the detection value to generate a q-axis current pulsation command,
an addition unit generating a second q-axis current command by adding together the first q-axis current command and the q-axis current pulsation command,
a flux-weakening control unit generating a d-axis current pulsation command for causing the d-axis current to pulsate in synchronization with the q-axis current pulsation command, a flux-weakening control unit generating a first d-axis current command from a voltage deviation between a dq-axis voltage command and a voltage limit value, the first d-axis current command having a frequency lower than a frequency of the d-axis current pulsation command, the flux-weakening control unit adding together the first d-axis current command and the d-axis current pulsation command to generate a second d-axis current command, and
a current control unit controlling a current flowing to the motor, using the second q-axis current command and the second d-axis current command, and generating the dq-axis voltage command.

12. The power converting apparatus according to claim 11, wherein
the flux-weakening control unit includes
a d-axis current pulsation generation unit generating the d-axis current pulsation command for reducing increase and decrease in an amplitude of the dq-axis voltage command, the increase and decrease being caused by the q-axis current pulsation, the d-axis current pulsation command being synchronized with the q-axis current pulsation, and
a d-axis current pulsation readjustment unit examining an amount of the increase and decrease in the amplitude of the dq-axis voltage command, and readjusting the d-axis current pulsation command in accordance with the amount of the increase and decrease, the increase and decrease being caused by the q-axis current pulsation command and the d-axis current pulsation command, and
the flux-weakening control unit adds together the first d-axis current command and the readjusted d-axis current pulsation command to generate the second d-axis current command.

13. The power converting apparatus according to claim 11, wherein
the flux-weakening control unit includes
a d-axis current pulsation generation unit generating, depending on the voltage deviation, the d-axis current pulsation command for reducing increase and decrease in an amplitude of the dq-axis voltage command, and
the d-axis current pulsation generation unit includes
Fourier coefficient computing units that extract, from the voltage deviation, a sine component and a cosine component separately as direct-current components, of a specified frequency component based on the q-axis current pulsation command,
integral control units that provide control to bring to zero the sine component and the cosine component of the frequency component extracted by the Fourier coefficient computing units, and
an alternating-current restoration unit restoring a single alternating-current signal from computation results from the integral control units, and outputs the single alternating-current signal as the d-axis current pulsation command.

14. The power converting apparatus according to claim 11, wherein
the flux-weakening control unit includes
a d-axis current pulsation generation unit generating, depending on the voltage deviation, the d-axis current pulsation command for reducing increase and decrease in an amplitude of the dq-axis voltage command, and
the d-axis current pulsation generation unit includes
first Fourier coefficient computing units that extract, from the voltage deviation, a sine component and a cosine component separately as direct-current components, of a specified first frequency component based on the q-axis current pulsation command,
first integral control units that provide control to bring to zero the sine component and the cosine component of the first frequency component extracted by the first Fourier coefficient computing units,
a gain unit multiplying a frequency of the q-axis current pulsation command by N, N being a positive integer greater than or equal to 2,
second Fourier coefficient computing units that extract, from the voltage deviation, a sine component and a cosine component separately as direct-current components, of a second frequency component obtained by the gain unit,
second integral control units that provide control to bring to zero the sine component and the cosine component of the second frequency component extracted by the second Fourier coefficient computing units, and
an alternating-current restoration unit restoring a single alternating-current signal from computation results from the first integral control units and from computation results from the second integral control units, and outputs the single alternating-current signal as the d-axis current pulsation command.

15. A motor drive unit comprising the power converting apparatus according to claim 1.

16. A refrigeration cycle-incorporating apparatus comprising the power converting apparatus according to claim 1.

17. A motor drive unit comprising the power converting apparatus according to claim 10.

18. A refrigeration cycle-incorporating apparatus comprising the power converting apparatus according to claim 10.
